(19) United States
(12) Patent Application Publication
(10) Pub. No.: US 2025/0351039 A1
(43) Pub. Date: Nov. 13, 2025

(54) TEMPORARY TERRESTRIAL HANDOVER

(71) Applicant: Dell Products L.P., Round Rock, TX (US)

(72) Inventor: Ali Esswie, Calgary (CA)

(21) Appl. No.: 18/660,961

(22) Filed: May 10, 2024

(51) Int. Cl. H04W 36/08; H04W 36/00; H04W 36/30; H04W 36/36

(52) U.S. Cl. CPC H04W 36/083; H04W 36/0011; H04W 36/304; H04W 36/362

(57) ABSTRACT

A non-terrestrial radio network node may configure user equipment with conditional handover period information and conditional handover configuration information. During establishment of a connection to facilitate delivery of non-terrestrial traffic, the non-terrestrial node may configure a user equipment with an assigned conditional handover profile indication corresponding to the non-terrestrial traffic. Upon determining to suspend delivery of the non-terrestrial traffic during a network energy saving mode, the non-terrestrial node may transmit a conditional handover command, responsive to which the user equipment may determine, based on the assigned conditional handover profile indication and the conditional handover configuration information, a target terrestrial radio network node and may transmit a connection establishment request thereto. Responsive to a connection transfer request transmitted by the target terrestrial node, the non-terrestrial node may transmit session context information corresponding to the non-terrestrial traffic that the target node may use to facilitate delivery thereof during the conditional handover period.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QOS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise analyzing, by a serving radio network node comprising at least one processor, at least one energy parameter value, resulting from at least one energy parameter measurement, with respect to at least one energy saving criterion to result in at least one analyzed energy parameter value. Based on the at least one analyzed energy parameter value being determined to satisfy the at least one energy saving criterion, the method may further comprise determining, by the serving radio network node, to handover at least one user equipment with respect to which the serving radio network node is conducting a communication session, and facilitating, by the serving radio network node, transmitting, to the at least one user equipment, at least one handover command indicative that the at least one user equipment is to attempt handover, to at least one radio network node other than the serving radio network node, of at least one communication session being facilitated by the serving radio network node. The serving radio network node may be a non-terrestrial radio network node. The at least one radio network node other than the serving radio network node may be a terrestrial radio network node.

In an embodiment, the method may further comprise facilitating, by the serving radio network node, receiving conditional handover configuration information, directed to the serving radio network node by a core network entity, comprising at least one conditional handover profile indication and at least one target node signal strength rank value corresponding to the at least one conditional handover profile indication. The at least one conditional handover profile indication may be respectively associated with at least one quality of service. The at least one conditional handover profile indication may be usable by the serving radio network node to facilitate indicating, to the at least one user equipment, a target radio network node determination criterion that may be usable by the at least one user equipment to determine the at least one radio network node with respect to which the at least one user equipment is to attempt handover of the at least one communication session in response to the at least one handover command. The conditional handover configuration information may further comprise the at least one energy saving criterion. The conditional handover configuration information may further comprise at least one time value indicative of a conditional handover period during which the at least one communication session is to be facilitated by the at least one radio network node other than the serving radio network node.

The at least one user equipment may comprise multiple user equipment. The at least one communication session may comprise multiple communication sessions corresponding to the multiple user equipment.

Based on a quality of service corresponding to the communication session, the method may further comprise facilitating, by the serving radio network node, determining, with respect to each of the multiple user equipment, a conditional handover profile indication to result in multiple determined conditional handover profile indications respectively corresponding to the multiple user equipment. The at least one handover command may comprise multiple handover commands. The multiple handover commands may be directed to the multiple user equipment. A handover command directed to a particular user equipment of the multiple user equipment may comprise at least one of the multiple determined conditional handover profile indications corresponding to at least one quality of service associated with at least one of the at least one communication session corresponding the particular user equipment.

In an embodiment, the at least one energy saving criterion may comprise an energy use margin, wherein the multiple user equipment are determined based on an energy amount corresponding to the serving radio network node serving the multiple user equipment being equal to or greater than the energy use margin. The method may further comprise determining, by the serving radio network node, that the multiple user equipment are served via a serving downlink beam, facilitated by the serving radio network node, to result in a determined serving downlink beam. The transmitting of the at least one handover command to the multiple user equipment may be based on the multiple user equipment being served by the determined serving downlink beam.

In an embodiment, the method may further comprise suspending, by the serving radio network node during a session halting period, operation with respect to the multiple communication sessions, and, during the session halting period, receiving session transfer information, directed to the serving radio network node by a network entity associated with the at least one radio network node other than the serving radio network node, indicative of at least one of the multiple user equipment with respect to which at least one of the multiple communication sessions are to be facilitated by the at least one radio network node other than the serving radio network node during a conditional handover period. Responsive to the session transfer information, the method may further comprise facilitating, by the serving radio network node, transmitting, to the at least one radio network node other than the serving radio network node, session context information corresponding to the multiple communication sessions that are to be facilitated by the at least one radio network node other than the serving radio network node. The method may further comprise deactivating, by the serving radio network node during the conditional handover period, operation with respect to the multiple communication sessions that are to be facilitated by the at least one radio network node other than the serving radio network node to result in deactivated communication sessions. The conditional handover period may begin after the session halting period. The method may further comprise resuming, by the serving radio network node after the conditional handover period, operation with respect to the deactivated communication sessions.

In an embodiment, the method may further comprise suspending, by the serving radio network node during a session halting period, operation with respect to the multiple communication sessions, and, during the session halting period, receiving session transfer information, directed to the serving radio network node by a network entity associated with the at least one radio network node other than the serving radio network node, indicative of a first set of the multiple user equipment with respect to which at least one of the multiple communication sessions are to be facilitated by the at least one radio network node other than the serving radio network node during a conditional handover period. Responsive to the session transfer information, the method may further comprise resuming, by the serving radio network node during the conditional handover period, operation with respect to the multiple communication sessions that correspond to a second set of the multiple user equipment that comprises user equipment of the multiple user equipment other than the first set of the multiple user equipment.

In another example embodiment, a non-terrestrial radio network node may comprising at least one processor configured to process executable instructions that, when executed by the at least one processor, facilitate performance of operations, comprising transmitting, to at least one user equipment, at least one conditional handover target node signal strength rank criterion associated with at least one communication session between the at least one user equipment and the non-terrestrial radio network node, and analyzing at least one energy parameter value, resulting from at least one energy parameter measurement, with respect to at least one energy saving criterion to result in at least one analyzed energy parameter value. Based on the at least one analyzed energy parameter value being determined to satisfy the at least one energy saving criterion, the operations may further comprise determining to handover the at least one user equipment, and transmitting, to the at least one user equipment, at least one conditional handover command indicative to the at least one user equipment to attempt transfer of at least one of the at least one communication session to at least one terrestrial radio network node according to the at least one conditional handover target node signal strength rank criterion. The at least one energy parameter measurement may correspond to at least one downlink beam associated with the non-terrestrial radio network node, and wherein the non-terrestrial radio network node is facilitating serving, via the at least one downlink beam, the at least one user equipment to which the at least one conditional handover command is transmitted.

In an embodiment, the at least one conditional handover target node signal strength rank criterion may be indicative of a rank, associated with at least one signal strength, or associated with a signal-to-interference-plus-noise ratio, corresponding to at least one terrestrial radio network node with respect to which the at least one user equipment determines a signal strength measurement, to be usable by the at least one user equipment to determine a first of the at least one terrestrial radio network node to which the at least one user equipment is to attempt handover, and wherein the at least one conditional handover target node signal strength rank criterion is based on at least one quality-of-service respectively corresponding to the at least one communication session.

In yet another example embodiment, a non-transitory machine-readable medium may comprise executable instructions that, when executed by at least one processor of a non-terrestrial radio network node, facilitate performance of operations that may comprise transmitting, to at least one user equipment, conditional handover determination configuration information comprising at least one conditional handover profile indication indicative of at least one conditional handover target node signal strength rank value. The operations may further comprise establishing, with the at least one user equipment, a non-terrestrial connection to result in at least one established non-terrestrial connection, wherein the establishing of the at least one established non-terrestrial connection comprises transmitting, to the at least one user equipment, at least one of the at least one conditional handover profile indication corresponding to the at least one established non-terrestrial connection to result in at least one connection-based conditional handover profile corresponding to the at least one established non-terrestrial connection. The operations may further comprise analyzing at least one energy parameter value, resulting from at least one energy parameter measurement, with respect to at least one energy saving criterion to result in at least one analyzed energy parameter value. Based on the at least one analyzed energy parameter value being determined to satisfy the at least one energy saving criterion, the operations may further comprise determining to handover the at least one user equipment, and transmitting, to the at least one user equipment, at least one handover command indicative to the at least one user equipment to attempt handover to at least one terrestrial radio network node according to at least one of the at least one conditional handover target node signal strength rank value corresponding to the at least one connection-based conditional handover profile.

In an embodiment, the conditional handover determination configuration information may further comprise at least one conditional handover time indication indicative of a time corresponding to a conditional handover period. The operations may further comprise halting, during a conditional handover evaluation period before the conditional handover period, operation with respect to the at least one established non-terrestrial connection. The operations may further comprise receiving, from at least one network element associated with at least one terrestrial radio network during the conditional handover evaluation period, at least one connection transfer indication indicative that at least one of the at least one user equipment has been handed over to at least one target terrestrial radio network node to result in at least one indicated handed over user equipment. Responsive to the at least one connection transfer indication, the operations may further comprise suspending, during the conditional handover period, operation of the at least one established non-terrestrial connection with respect to the at least one indicated handed over user equipment. The operations may further comprise resuming, after the conditional handover period, operation of the at least one established non-terrestrial connection with respect to the at least one indicated handed over user equipment.

In an embodiment, the conditional handover determination configuration information may further comprise at least one conditional handover time indication indicative of a time corresponding to a conditional handover period. The operations may further comprise halting, during a conditional handover evaluation period before the conditional handover period, operation with respect to the at least one established non-terrestrial connection, and failing to receive, from at least one network element associated with at least one terrestrial radio network during the conditional handover evaluation period, a connection transfer indication indicative that at least one of the at least one user equipment has been handed over to at least one target terrestrial radio network node to result in at least one determined non-handed-over user equipment. Responsive to the failing to receive a connection transfer indication corresponding to the at least one determined non-handed-over user equipment, the operations may further comprise resuming, during the conditional handover period, operation of the at least one established non-terrestrial connection with respect to the at least one determined non-handed-over user equipment.

Another example method embodiment may comprise facilitating, by a terrestrial radio network node that may comprise at least one processor, receiving, from at least one user equipment, at least one connection establishment request comprising a conditional handover indication. Responsive to the at least one connection establishment request and based on the conditional handover indication, the method may further comprise facilitating, by the terrestrial radio network node, directing, to at least one non-terrestrial radio network node that is facilitating at least one communication session with the at least one user equipment, at least one session transfer request indicative of at least one of the at least one user equipment with respect to which at least one of the at least one communication session is to be facilitated by the terrestrial radio network node. Responsive to the at least one session transfer request, the method may further comprise facilitating, by the terrestrial radio network node, receiving session transfer information, directed to the terrestrial radio network node by a first network element associated with the at least one non-terrestrial radio network node, corresponding to the at least one communication session to be facilitated by the terrestrial radio network node during a conditional handover period, and facilitating, by the terrestrial radio network node during the conditional handover period, delivery of traffic corresponding to the at least one communication session with respect to the at least one user equipment according to the session transfer information.

In an embodiment, the method may further comprise facilitating, by the terrestrial radio network node, receiving conditional handover configuration information, directed to the terrestrial radio network node by a second network element associated with the at least one non-terrestrial radio network node, wherein the conditional handover configuration information comprises at least one time value indicative of the conditional handover period.

In an embodiment, after the conditional handover period, the method may further comprise facilitating, by the terrestrial radio network node, directing, to a second network element associated with the at least one non-terrestrial radio network node, updated session information corresponding to the at least one communication session. The first network element and the second network element may be different. At least one of the first network element or the second network element, ay comprise at least one of: a core network element; a shared terrestrial/non-terrestrial network element; a gateway; or the at least one non-terrestrial radio network node.

In an embodiment, the updated session information may comprise at least one of: a downlink packet number corresponding to a last downlink packet delivered by the terrestrial radio network node to the at least one user equipment, a downlink packet number corresponding to a last downlink packet delivered by the terrestrial radio network node to the at least one user equipment, or a quality of service indication indicative of a quality of service associated with the at least one communication session.

In an embodiment, after the directing of the updated session information to the second network element, the method may further comprise flushing, by the terrestrial radio network node, the updated session information.

In an embodiment, the at least one connection establishment request may be transmitted by the at least one user equipment based on at least one conditional handover command, directed to the at least one user equipment by the at least one non-terrestrial radio network node, indicative to the at least one user equipment to attempt transfer of the at least one communication session according to at least one conditional handover target node signal strength rank. The terrestrial radio network node may correspond to the at least one conditional handover target node signal strength rank.

The terrestrial radio network node may be a first terrestrial radio network node that corresponds to a first signal strength, with respect to the at least one user equipment, and the first signal strength may be less than a second signal strength, with respect to the at least one user equipment, that corresponds to a second terrestrial radio network node.

In another example embodiment, a terrestrial radio network node may comprise at least one processor configured to process executable instructions that, when executed by the at least one processor, facilitate performance of operations that may comprise receiving, from a user equipment, a connection establishment request comprising a conditional handover indication indicative of a request to handover, to the terrestrial radio network node, delivery of communication traffic corresponding to a communication session being facilitated by a non-terrestrial radio network node. Responsive to the conditional handover indication, the operations may further comprise transmitting, to the non-terrestrial radio network node, a transfer request indicative of the user equipment. Responsive to the transfer request, the operations may further comprise receiving session transfer information, directed to the terrestrial radio network node by a first network element associated with the non-terrestrial radio network node, corresponding to the communication session to be facilitated by the terrestrial radio network node during a conditional handover period, and delivering, during the conditional handover period, the communication traffic according to the session transfer information.

In an embodiment, the terrestrial radio network node may be a first terrestrial radio network node. A first terrestrial signal strength, corresponding to the first terrestrial radio network node, with respect to the user equipment may be lower than a second terrestrial signal strength, corresponding to a second terrestrial radio network node, with respect to the user equipment. The first terrestrial signal strength may correspond to a conditional handover target node signal strength rank that corresponds to a quality of service corresponding to the communication session.

The connection establishment request may be transmitted by the user equipment based on a conditional handover command, directed to the user equipment by the non-terrestrial radio network node, indicative to the user equipment to attempt transfer of the communication session. The conditional handover command maybe indicative to the user equipment to attempt transfer according to the conditional handover target node signal strength rank.

In an embodiment, the connection establishment request may comprise a non-terrestrial radio network node identifier indicative of the non-terrestrial radio network node with respect to which handover of the delivering of the communication traffic is requested by the connection establishment request.

In an embodiment, responsive to the transfer request, the operations may further comprise receiving, from the non-terrestrial radio network node, at least one time indication indicative of the conditional handover period.

In an embodiment, after expiration of the conditional handover period, the operations may further comprise directing, to the non-terrestrial radio network node, updated session information corresponding to the delivering, during the conditional handover period, of the communication traffic. After the directing of the updated session information to the non-terrestrial radio network node, the operations may further comprise flushing the updated session information.

In yet another example embodiment, a non-transitory machine-readable medium may comprise executable instructions that, when executed by at least one processor of a terrestrial radio network node, facilitate performance of operations that may further comprise receiving, from a user equipment, a connection establishment request comprising a conditional handover indication indicative of a request to handover, to the terrestrial radio network node, delivery of communication traffic corresponding to a communication session being facilitated by a non-terrestrial radio network node. Responsive to the conditional handover indication, the operations may further comprise transmitting, to the non-terrestrial radio network node a session transfer request indicative of the user equipment. Responsive to the session transfer request, the operations may further comprise receiving session transfer information, comprising session context information corresponding to the communication session, directed to the terrestrial radio network node by a first network element associated with the non-terrestrial radio network node, corresponding to the communication session to be facilitated by the terrestrial radio network node during a conditional handover period. The operations may further comprise facilitating, during the conditional handover period, delivering of the communication traffic according to the session transfer information, and determining that the conditional handover period has expired. Based on the conditional handover period being determined to have expired, the operations may further comprise directing, to the non-terrestrial radio network node, updated session information corresponding to the delivery, during the conditional handover period, of the communication traffic, and flushing the updated session information.

In an embodiment, the terrestrial radio network node may be a first terrestrial radio network node. A first terrestrial signal strength corresponding to the first terrestrial radio network node with respect to the user equipment may be lower than a second terrestrial signal strength corresponding to a second terrestrial radio network node with respect to the user equipment. The first terrestrial signal strength may correspond to a conditional handover target node signal strength rank. The connection establishment request may be transmitted by the user equipment based on a conditional handover command, directed to the user equipment by the non-terrestrial radio network node, indicative to the user equipment to attempt transfer of the communication session according to the conditional handover target node signal strength rank. The conditional handover command may be indicative to the user equipment to transmit the connection establishment request to the terrestrial radio network node. The conditional handover command may be indicative to the user equipment to transmit the connection establishment request according to the conditional handover target node signal strength rank.

The conditional handover target node signal strength rank may correspond to a quality of service associated with the communication session. The connection establishment request may comprise a non-terrestrial radio network node identifier indicative of the non-terrestrial radio network node with respect to which handover of the delivery of the communication traffic is requested by the connection establishment request.

In yet another example embodiment, a method may comprise receiving, by a user equipment comprising at least one processor from a non-terrestrial radio network node, a conditional handover command indicative that the user equipment is to attempt a handover, to at least one terrestrial radio network node, of at least one communication session being facilitated by the non-terrestrial radio network node, and responsive to the conditional handover command, attempting, by the user equipment, to establish a connection with a first terrestrial radio network node of the at least one terrestrial radio network node based on at least one conditional handover profile target node signal strength rank criterion associated with at least one of the at least one communication session.

In an embodiment, the at least one conditional handover profile target node signal strength rank criterion may comprise a signal rank indicative that the user equipment is to attempt, responsive to the conditional handover command, connection establishment with a terrestrial radio network node corresponding to a signal strength that is less than a best signal strength corresponding to a terrestrial radio network node other than the first terrestrial radio network node.

In an embodiment, the method may further comprise determining, by the user equipment, a first signal strength corresponding to the first terrestrial radio network node to result in a determined first signal strength, and determining, by the user equipment, a second signal strength corresponding to a second terrestrial radio network node to result in a determined second signal strength, wherein the determined second signal strength is stronger than the determined first signal strength.

In an embodiment, the at least one conditional handover profile target node signal strength rank criterion may correspond to at least one quality of service associated with the at least one communication session.

In an embodiment, the method may further comprise receiving, by the user equipment, conditional handover configuration information, directed to the user equipment by a network element associated with the non-terrestrial radio network node, comprising at least one conditional handover profile indication associated with the at least one conditional handover profile target node signal strength rank criterion.

The conditional handover configuration information may further comprise at least one time value indicative of a conditional handover period during which the at least one communication session is to be facilitated by a terrestrial radio network node with respect to which the user equipment determines a signal strength that satisfies the at least one conditional handover profile target node signal strength rank criterion.

In an embodiment, the attempting to establish the connection with the first terrestrial radio network node may further comprise determining, by the user equipment, a first signal strength corresponding to the first terrestrial radio network node to result in a determined first signal strength, and determining, by the user equipment, that the determined first signal strength satisfies the at least one conditional handover profile target node signal strength rank criterion. Based on at least one configured connection establishment criterion, the attempting to establish the connection with the first terrestrial radio network node may further comprise determining, by the user equipment, that the connection with the first terrestrial radio network node is capable of being established to result in a determined capable connection. Based on the determined capable connection, the attempting to establish the connection with the first terrestrial radio network node may further comprise establishing, by the user equipment, the connection with the first terrestrial radio network node to result in an established connection. The method may further comprise facilitating, by the user equipment with the first terrestrial radio network node during the conditional handover period, delivery, via the established connection, of traffic corresponding to the at least one communication session.

After the conditional handover period, the method may further comprise resuming, by the user equipment with the non-terrestrial radio network node, facilitation of delivery of traffic corresponding to the at least one communication session.

The establishing of the connection with the first terrestrial radio network node may further comprise transmitting, to the first terrestrial radio network node, at least one connection establishment request comprising a non-terrestrial network node identifier, indicative of the non-terrestrial radio network node, to be usable by the first terrestrial radio network node to direct, to the non-terrestrial radio network node, a session transfer request indicative of the user equipment with respect to which the at least one communication session is to be facilitated by the first terrestrial radio network node.

In an embodiment, the attempting to establish the connection with the first terrestrial radio network node may further comprise determining, by the user equipment, a first signal strength corresponding to the first terrestrial radio network node to result in a determined first signal strength, and determining, by the user equipment, that the determined first signal strength satisfies the at least one conditional handover profile target node signal strength rank criterion. Based on at least one configured connection establishment criterion, the attempting to establish the connection with the first terrestrial radio network node may further comprise determining, by the user equipment, that the connection with the first terrestrial radio network node is incapable of being established. Based on establishment of the connection with the first terrestrial radio network node being determined to be incapable, the attempting to establish the connection with the first terrestrial radio network node may further comprise avoiding, by the user equipment, establishing the connection with the first terrestrial radio network node. The conditional handover configuration information may further comprise at least one conditional handover halting period indication indicative of at least one conditional handover halting period, during which the non-terrestrial radio network node is to avoid handing over delivery of the at least one communication session to the at least one terrestrial radio network node. The method may further comprise resuming, by the user equipment after the at least one conditional handover halting period, facilitation, with the non-terrestrial radio network node, of delivery of traffic corresponding to the at least one communication session.

In another embodiment a user equipment may comprise at least one processor configured to process executable instructions that, when executed by the at least one processor, facilitate performance of operations that may comprise receiving, from a non-terrestrial radio network node, a conditional handover command indicative that the user equipment is to attempt a handover of a communication session being facilitated by the non-terrestrial radio network node via an established non-terrestrial connection, and determining a terrestrial radio network node corresponding to a determined terrestrial signal strength that satisfies at least one conditional handover target node signal strength rank criterion associated with the communication session to result in a determined terrestrial radio network node. Responsive to the conditional handover command, the operations may further comprise attempting to establish a connection with the determined terrestrial radio network node.

The at least one conditional handover target node signal strength rank criterion may comprise a signal rank indicative that the user equipment is to attempt, responsive to the conditional handover command, connection establishment with the determined terrestrial radio network node based on the determined terrestrial signal strength being determined to be less than at least one terrestrial signal strength, corresponding to at least one terrestrial radio network node, that is less than the determined terrestrial signal strength.

In an embodiment, the attempting to establish the connection may further comprise transmitting, to the determined terrestrial radio network node, a connection establishment request comprising a non-terrestrial network node identifier, indicative of the non-terrestrial radio network node, to be usable by the determined terrestrial radio network node to direct, to the non-terrestrial radio network node, a session transfer request indicative of the user equipment with respect to which the communication session is to be facilitated by the determined terrestrial radio network node. The operations may further comprise establishing, with the determined terrestrial radio network node, the connection to result in an established terrestrial connection, and conducting the communication session with the determined terrestrial radio network node via the established terrestrial connection during a conditional handover period that begins after a conditional handover halting period. After the conditional handover period, the operations may further comprise resuming, with the non-terrestrial radio network node via the established non-terrestrial connection, the communication session.

In yet another embodiment, a non-transitory machine-readable medium may comprise executable instructions that, when executed by at least processor of a user equipment, may facilitate performance of operations that may comprise receiving conditional handover configuration information comprising a conditional handover profile indication indicative of a conditional handover profile target node signal strength rank criterion and at least one time value indicative of a conditional handover period during which a communication session with respect to the user equipment that is being facilitated by a non-terrestrial radio network node via an established non-terrestrial connection is to be handed over to a terrestrial radio network node, and receiving, from the non-terrestrial radio network node, a conditional handover command indicative that the user equipment is to attempt a handover of the communication session according to the conditional handover configuration information. Responsive to the conditional handover command, the operations may further comprise establishing a first connection with a terrestrial radio network node based on a terrestrial signal strength, corresponding to the terrestrial radio network node, being determined to satisfy the conditional handover profile target node signal strength rank criterion associated with the communication session to result in an established terrestrial connection, and conducting, during the conditional handover period, the communication session with the terrestrial radio network node according to the established terrestrial connection.

In an embodiment, the terrestrial radio network node may be a first terrestrial radio network node. The terrestrial signal strength may be a first terrestrial signal strength. The operations may further comprise determining a second terrestrial signal strength, corresponding to a second terrestrial radio network node, that is stronger than the first terrestrial signal strength. Based on the second terrestrial signal strength being determined to not satisfy the conditional handover profile target node signal strength rank criterion, the operations may further comprise avoiding attempting, in response to the conditional handover command, to establish a second connection with the second terrestrial radio network node.

In an embodiment, the establishing of the established terrestrial connection may further comprise transmitting, to the terrestrial radio network node, at least one connection establishment request comprising a non-terrestrial network node identifier, indicative of the non-terrestrial radio network node, to be usable by the terrestrial radio network node to direct, to the non-terrestrial radio network node, a session transfer request indicative of the user equipment with respect to which the communication session is to be facilitated by the terrestrial radio network node.

In an embodiment, the conditional handover configuration information may further comprise a conditional handover halting period indication indicative of a conditional handover halting period, during which the non-terrestrial radio network node is to avoid handing over the communication session to the terrestrial radio network node, and wherein the conditional handover period begins after the conditional handover halting period.

In an embodiment, after the conditional handover period, the operations may further comprise resuming, with the non-terrestrial radio network node, the communication session according to the established non-terrestrial connection. The operations may further comprise avoiding, during the conditional handover period, flushing connection context information associated with the established non-terrestrial connection.

### BRIEF DESCRIPTION OF THE DRAWINGS

FIG. 1 illustrates wireless communication system environment.

FIG. 2 illustrates an environment with a satellite base station/gateway and satellite that are capable of communication of traffic corresponding to a radio access network.

FIG. 3 illustrates an example environment with a terrestrial radio network node facilitating conditional handover of non-terrestrial traffic being facilitated by a non-terrestrial radio network node.

FIG. 4 illustrates example conditional handover configuration information.

FIG. 5 illustrates example conditional handover target node signal strength rank criterion configuration information.

FIG. 6 illustrates example conditional handover target node signal strength rank criterion configuration information and associated profile indication information and quality of service information.

FIG. 7 illustrates example conditional handover target node signal strength rank criterion corresponding to non-terrestrial traffic being facilitated by the non-terrestrial radio network node.

FIG. 8 illustrates an example conditional handover command being transmitted by a non-terrestrial radio network node via a non-terrestrial beam to user equipment receiving non-terrestrial traffic via the non-terrestrial beam.

FIG. 9 illustrates example connection transfer indication information directed to a non-terrestrial radio network node by a network element associated with the non-terrestrial radio network node or by a terrestrial radio network node.

FIG. 10 illustrates a timeline of a conditional handover session halting period/evaluation period followed by a conditional handover period.

FIG. 11 illustrates a timing diagram of a non-terrestrial radio network node facilitating handover of traffic to a terrestrial radio network node.

FIG. 12 illustrates a timing diagram of a terrestrial radio network node facilitating delivering of traffic handed over from a non-terrestrial radio network node.

FIG. 13 illustrates a timing diagram of a user equipment facilitating conditional handover of delivery of traffic from being facilitated by a non-terrestrial radio network node to being facilitated by a terrestrial radio network node.

FIG. 14 illustrates a flow diagram of an example method to conditionally handover traffic from being delivered by a non-terrestrial radio network node to being facilitated by a terrestrial radio network node.

FIG. 15 illustrates a block diagram of an example method.

FIG. 16 illustrates a block diagram of an example non-terrestrial radio network node.

FIG. 17 illustrates a block diagram of an example non-transitory machine-readable medium.

FIG. 18 illustrates a block diagram of an example method.

FIG. 19 illustrates a block diagram of an example terrestrial radio network node.

FIG. 20 illustrates a block diagram of an example non-transitory machine-readable medium.

FIG. 21 illustrates a block diagram of an example method.

FIG. 22 illustrates a block diagram of an example user equipment.

FIG. 23 illustrates a block diagram of an example non-transitory machine-readable medium.

FIG. 24 illustrates an example computer environment.

FIG. 25 illustrates a block diagram of an example wireless UE.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence (“AI”) and machine learning (“ML”) models may facilitate performance and operational functionality and improvements in 5G implementation, such as, for example, network automation, optimizing signaling overhead, energy conservation at devices, and traffic-capacity maximization. An artificial intelligence machine learning models (“AI/ML model”) functionality can be implemented and structured in many different forms and with varying vendor-proprietary designs. A 5G radio access network node (“RAN”) of a network to which the user equipment may be attached or with which the user equipment may be registered may manage or control real-time AI/ML model performance at different user equipment devices for various radio functions.

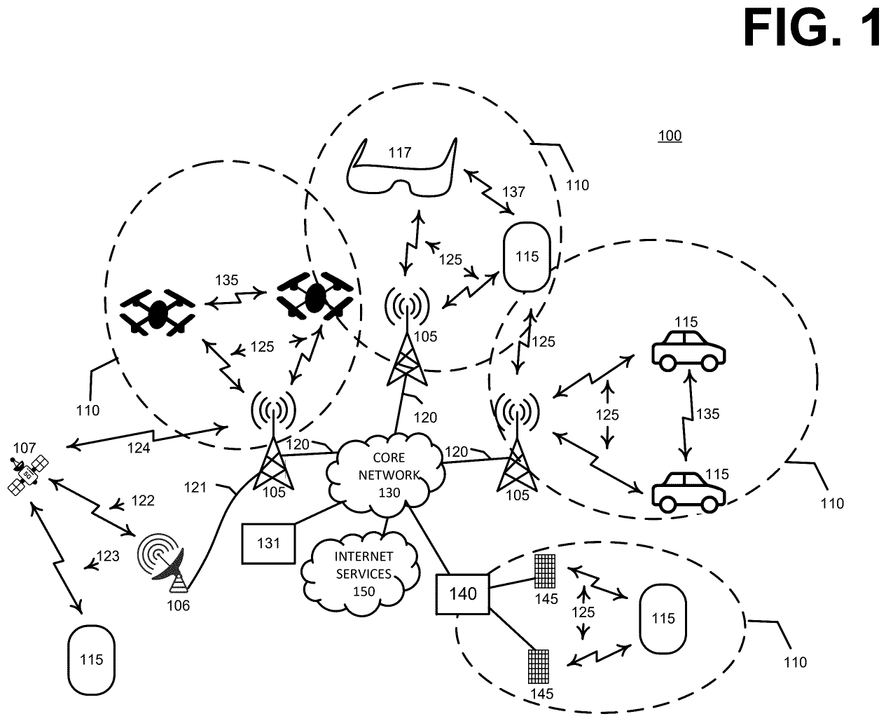

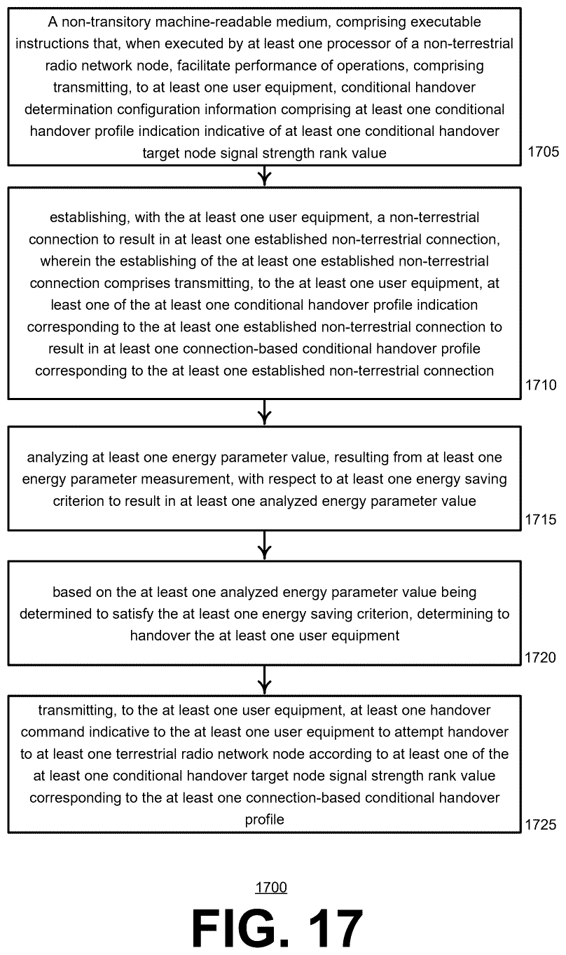

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 17.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies. such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 and 124 to satellite node 107, and links 123 from satellite/node 107 to UE 115, may comprise line-of-sight microwave signal transmission. A UE 115 may be configured with at least one antenna, or at least one processor, to facilitate transmitting or receiving microwave signals to/from satellite node 107. Description herein of, or reference herein to, a radio node or a radio network node may be a description of or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial radio network node may be referred to as a “TN” node. Reference to a satellite node, or a non-terrestrial network node (“NTN node”), may comprise a reference to satellite 107, base station gateway 106, or a combination of satellite 107 and base station/gateway 106.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient.

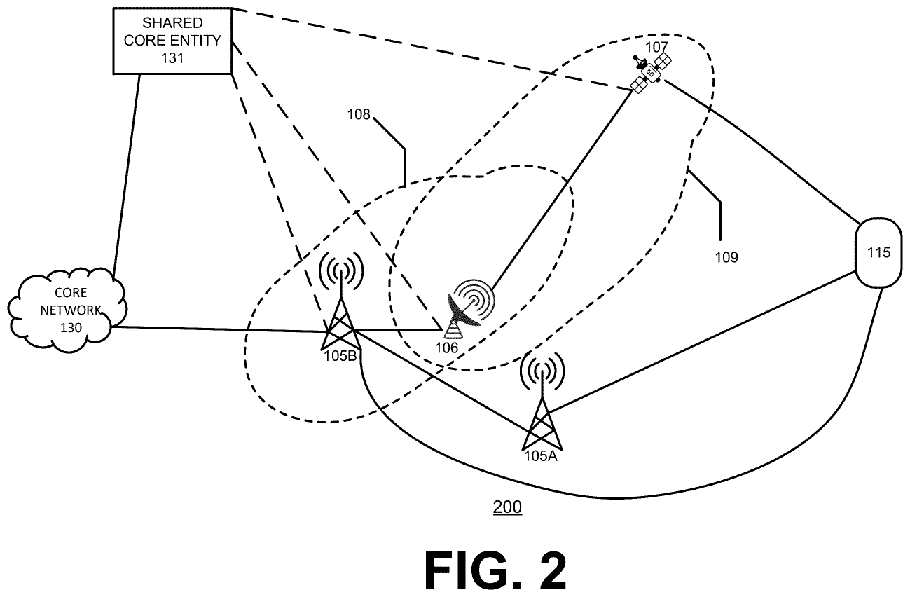

Turning now to FIG. 2, the figure illustrates ground-based RAN node 105, base station 106, and NTN node 107, any one or more of which may be referred to as a radio network node. In reference to some embodiments disclosed herein, reference to a TN node may comprise a reference to node 108, which may comprise one or more of terrestrial RAN node 105 or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105. RAN node 105 may communicate directly with satellite node 107 via communication links 124 or via gateway 106 via links 121 and 122.

It may be desirable to implement gNodeB/RAN node functionality on board an NTN node/satellite node to serve user equipment. However, implementing RAN node functionality in an NTN node may give rise to performance limitations that may impact overall operation. For example, an NTN node implementing gNodeB functionality may consume energy at a rate similar to, or greater than, an energy consumption rate corresponding to a terrestrial RAN node due to providing similar functionality as the terrestrial node but providing the functionality to a potentially much larger number of user equipment because of a much wider coverage area corresponding to a non-terrestrial node with respect to a coverage area corresponding to a terrestrial node. Moreover, a non-terrestrial network node typically operates with a more limited energy source (e.g., a battery) as compared to an energy source corresponding to a terrestrial node (e.g., connection to a local electric power grid).

Therefore, it may be desirable to offload energy-consumption-heavy radio operations from an NTN node to a terrestrial node if power consumed by an NTN/satellite node is deemed excessive or poses a risk to the NTN node/satellite (e.g., tending to cause a dead battery at the NTN node). It may be desirable to facilitate controlling energy consumption of an NTN satellite node while offering full radio access network node functionality to user equipment devices.

Conditional handover (“CHO”) techniques may reduce handover signaling overhead but may not actually facilitate offloading traffic delivery from NTN nodes to TN nodes when an energy starvation is exhibited at an NTN RAN to reduce energy consumption at the NTN node during a network energy saving mode. According to conventional techniques, CHO is solely triggered by user equipment devices and thus CHO triggering is not controlled by NTN RAN nodes. Furthermore, CHO triggering according to conventional techniques is solely based on relative coverage conditions determined by a user equipment (e.g., based on a best or strongest signal strength) and is thus energy-consumption-agnostic with respect to energy consumption at a serving NTN node.

According to embodiments disclosed herein, conditional handover of user equipment may facilitate the user equipment requesting connection to a TN node offering received coverage (e.g., corresponding to a measured signal strength) that satisfies a target TN node determining criterion that minimizes control signaling overhead to implement the CHO. To implement CHO according to embodiments disclosed herein, user equipment devices may be configured with CHO coverage condition criterion, or criteria, whereupon determining, by the user equipment, satisfaction thereof in response to receiving a conditional handover command from an NTN node the user equipment may trigger CHO to a target terrestrial node that corresponds to a signal strength rank with respect to signal strength ranks corresponding to other potential terrestrial nodes. According to embodiments disclosed herein, CHO may be implemented according to configured time-based conditional handover configuration information. A conditional handover may be triggered solely based on a source NTN node experiencing energy starvation and may be limited to a configured conditional handover period.

According to embodiments disclosed herein, configured conditional handover profiles may be associated with an active communication session or a service or QoS corresponding thereto. According to embodiments disclosed herein, facilitation of traffic delivery by an NTN node that has determined to implement a conditional handover to facilitate network energy saving may be temporarily halted. Facilitation of traffic delivery by an NTN node that has determined to implement a conditional handover may be dynamically resumed by the NTN node, during a configured and commanded conditional handover period, with respect to user equipment depending on the state of the user equipment.

According to conventional techniques, handover behavior of TN RAN nodes dictates that handover be triggered only when a coverage measurement report, determined by user equipment, is received from a user equipment indicative of a better/stronger (e.g., relative) received coverage level/signal strength corresponding to another RAN node (e.g., target RAN node) as compared to a currently serving RAN node. Thus, according to conventional techniques, handover may be executed toward a target RAN node based on a signal strength corresponding to the target node being stronger than a signal strength corresponding to the currently serving RAN node.

Unlike conventional techniques, according to embodiments disclosed herein a time-bound handover that results from a temporary energy saving mode activation at a currently serving node may be implemented. According to embodiments disclosed herein, a target terrestrial RAN node may temporarily handle traffic corresponding to handed-over user equipment devices during a configured CHO period. After a CHO period expires, a target terrestrial RAN node may autonomously revert handed over communication session traffic back to a source non-terrestrial RAN node without being triggered by a user equipment device measurement report (e.g., conditional handover according to embodiments disclosed herein may be time-bounded or time-limited).

According to conventional techniques, a user equipment may implement a static device execution stack with respect to handover. Handover from one node to another according to conventional techniques is triggered based on a coverage-level value corresponding to a target node being higher/stronger/better than the coverage level value corresponding to a currently serving node. Thus, user equipment may camp on or attempt to connect with a target RAN corresponding to a stronger signal strength than a signal strength corresponding to a currently serving brand node, and with respect to which signal strength or other radio parameter values may satisfy configured coverage condition criteria.

According to techniques disclosed herein, NTN-capable user equipment devices (e.g., user equipment that are designed or configured to communicate with a non-terrestrial radio network node/satellite node according to uplink and downlink non-terrestrial frequency or time resource), currently camped on or being served by a non-terrestrial radio network node, may perform time-bounded conditional handover towards a target TN RAN node that may or may not be offering a best received coverage level as determined by the user equipment, but instead may be based on an assigned conditional handover profile that is associated with a quality-of-service corresponding to traffic being facilitated by the non-terrestrial radio network node or that is associated with a service corresponding to the user equipment device.

Due to the nature of an NTN interface of an NTN node, an NTN node has a capacity to serve a much larger number of user equipment than a TN RAN node over a much larger geographic coverage area than a TN RAN node can cover. Due to the larger geographic coverage area corresponding to an NTN node, an NTN-capable user equipment within coverage of an NTN node may not necessarily be within a coverage area corresponding to a terrestrial radio network node such that the NTN-capable user equipment can detect one or more TN RAN nodes that correspond to reasonable a signal strength coverage level at the NTN-capable user equipment. Thus, conventional device-group handover techniques are not directly adaptable to handover from an NTN node to a TN node. For example, an NTN RAN node may trigger CHO for a large group of NTN-capable user equipment devices (e.g., 100 user equipment devices located in close proximity with one another) that may all select the same TN RAN node to camp on or connect to if the TN RAN node provides a best signal strength as determined by the 100 user equipment device, thus leading to potential overwhelming of TN capacity and resources corresponding to the selected TN RAN node. Embodiments disclosed herein may facilitate a conditional handover being time-limited to periods of expected NTN RAN node energy starvation (or time-limited to implemented NES periods during which an NTN node may suspend traffic delivery corresponding to user equipment being served by the NTN node), while accommodating actual radio conditions at NTN-capable user equipment devices such that radio sessions corresponding to the user equipment are not disrupted. Techniques disclosed herein may facilitate novel CHO signaling procedures at both an NTN node currently serving one or more user equipment and at target TN RAN nodes that may facilitate temporary conditional handover of traffic currently being facilitated by the non-terrestrial node. According to techniques disclosed herein, user equipment may implement novel handover procedures that may result in a user equipment determining a TN node with which to establish a connection, for purposes of a conditional handover, that does not necessarily correspond to a strongest signal strength determined, by the user equipment, with respect to multiple TN RAN nodes.

### Adaptive Non-Terrestrial Conditional Handover.

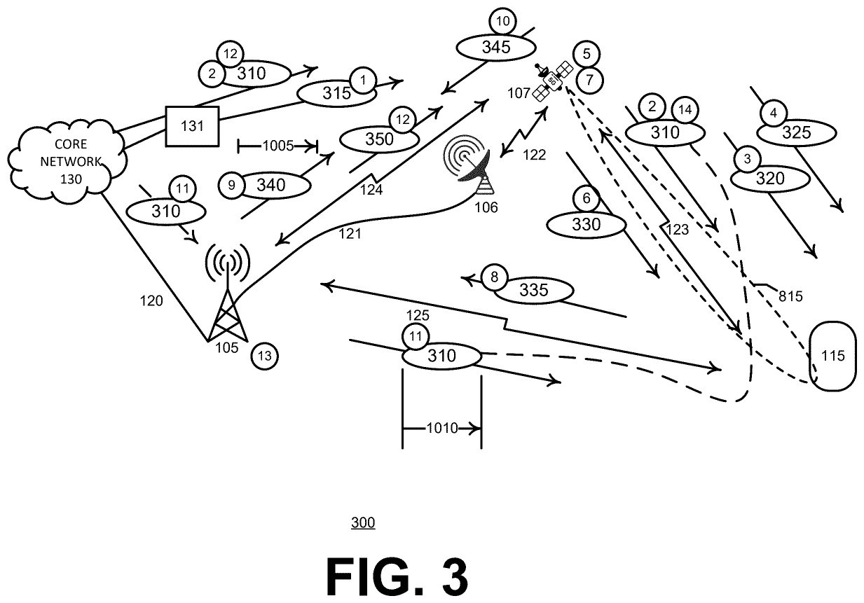

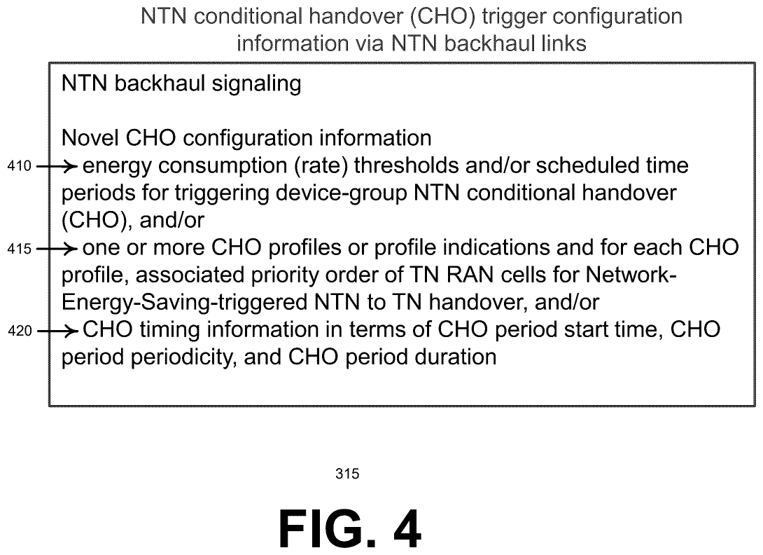

Turning now to FIG. 3, the figure illustrates an environment 300 with a user equipment 115 having selected NTN node 107 as a serving node. At act 2, UE 115 may be operating in an idle mode with respect to node 107 or may be operating in a connected state with respect to NTN node 107 or may be conducting a communication session, comprising delivery of communication traffic 310, with the NTN node. UE 115 may be, or may not be, in a coverage range of terrestrial radio network node 105. At act 1, non-terrestrial network node 107 may receive an energy saving criterion message 315 from at least one of terrestrial/non-terrestrial core network shared entity 131, non-terrestrial network gateway 106, or terrestrial radio network node 105. Message 315 may be referred to as, or may comprise, conditional handover configuration information. As shown in FIG. 4, message 315 may comprise, in field 410, a criterion, for example an energy consumption threshold, and/or in field 420 at least one time indication indicative of one or more scheduled time periods during which NTN node 107 may handover delivery of at least one traffic flow corresponding to communication traffic 310 between NTN node 107 and UE 115, which may be an NTN-capable user equipment designed or configured to communicate with non-terrestrial radio network nodes according to non-terrestrial resources. In field 415, message 315 may comprise conditional handover profile indication information that may comprise at least one conditional handover profile indication/identifier/index and at least one target node signal strength rank value. The at least one conditional handover profile indication 415 may be respectively associated with at least one quality of service respectively associated with at least one traffic flow corresponding to traffic 310. The at least one conditional handover profile indication 415 may be usable by NTN node 107 to facilitate indicating, to user equipment 115, a target radio network node determination criterion that is to be usable by UE 115 to determine a radio network node (e.g., terrestrial radio network node 105) with respect to which the user equipment is to attempt, at act 8, handover of part of, or all of, traffic 310 in response to a handover command 330 received by UE 115 from NTN node 107.

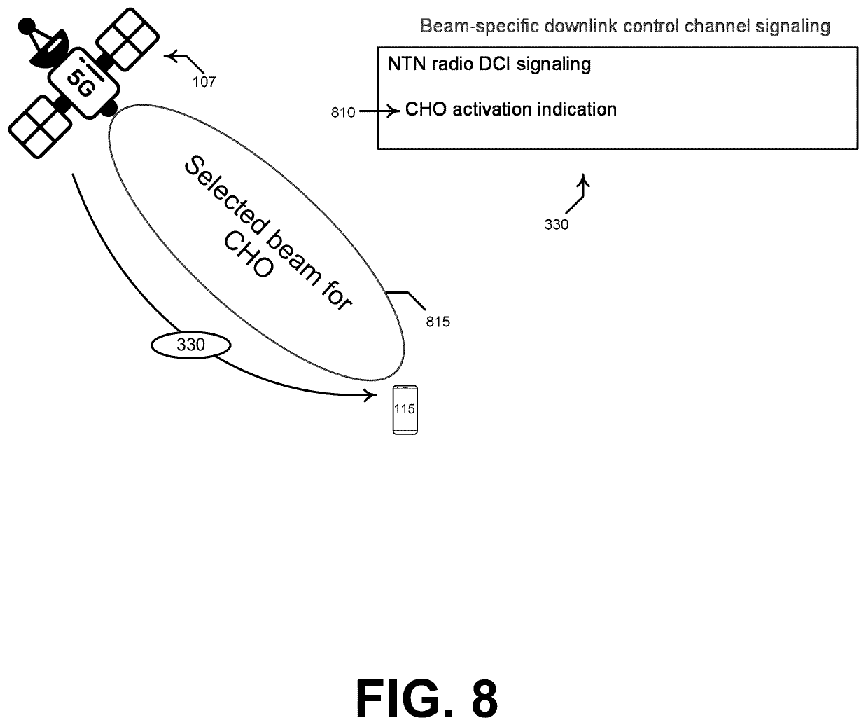

At act 5, NTN node 107 may analyze at least one energy parameter value, resulting from at least one energy parameter measurement corresponding to the NTN node, with respect to the at least one energy saving criterion 410 to result in an analyzed at least one energy parameter value. The energy parameter measurement may be determined by node 107 and may comprise a charge level corresponding to a battery that provides electricity to node 107, an electric current flow at the node, an electric voltage level at the node, an energy consumption rate at the node, a power usage value at the node, and the like. At act 5, based on the analyzed at least one energy parameter value being determined to satisfy the at least one energy saving criterion 410, for example NTN RAN node 107 may determine that a battery charge level at the node is equal to or less than a battery charge criterion, the NTN RAN node may determine to temporarily/conditionally handover delivery of part of, or all of, traffic 310 to terrestrial radio network node 105. Message 315 received by non-terrestrial RAN node/cellular satellite 107 may comprise at least one energy consumption rate threshold, or at least one time indication indicative of scheduled time periods during which device-group NTN conditional handover (“CHO”) may be triggered. NTN node 107 may execute NES-triggered CHO (e.g., CHO triggered by determining to implement a network energy saving mode at the NTN node) for one or more groups of active NTN devices 115 being serviced by at least one available NTN downlink beam (e.g., beam 815 shown in FIG. 8) corresponding to the NTN node (e.g., NTN node 107 may trigger CHO of traffic corresponding to a group of user equipment being served by a particular downlink beam upon determining an increasing energy consumption rate at the NTN node that exceeds a threshold configured via information received via message 315).

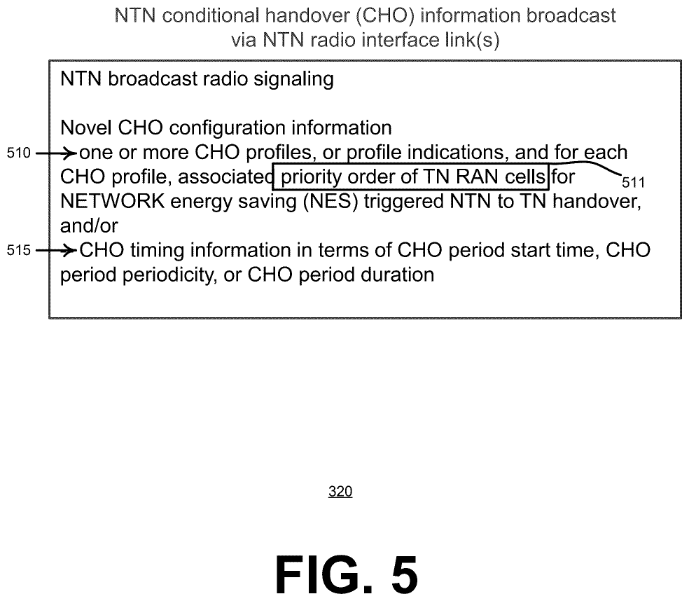

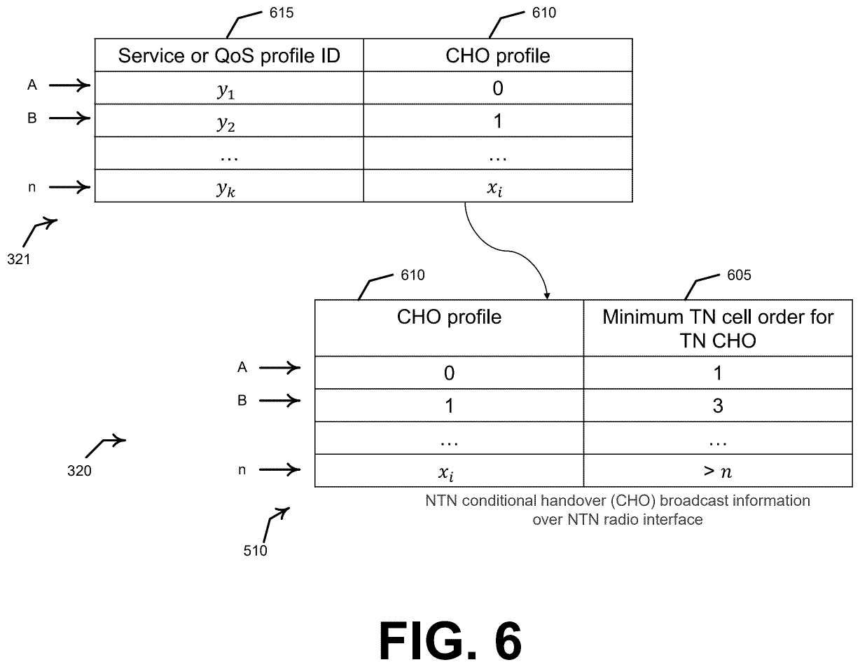

As shown in FIG. 5, NTN RAN node 107 may broadcast, at act 3 via at least one NTN radio interface link 123, conditional handover determination configuration information message 320, which may comprise at least one conditional handover profile indication associated with at least one conditional handover profile target node signal strength rank value. Conditional handover determination configuration information contained in message 320 may comprise device-group-specific NTN CHO configuration information that may be received via message 315 from gateway 106, an element of core network 131, shared NTN-TN element 131, or from terrestrial radio network node 105 via at least one backhaul interface link, and may comprise, as shown in FIG. 5, one or more CHO profiles or profile indications in field 510. For each CHO profile indicated in field 510, message 320 may comprise an associated conditional handover profile target node signal strength rank value 511, or indication thereof, indicative of a priority rank, or a highest signal strength ranking in an order of signal strengths, corresponding to TN RAN nodes that may be available to UE 115 for network-energy-saving-triggered handover of NTN traffic to a TN node. Configuration information in message 320 may comprise CHO timing information in field 515 indicative of at least one conditional handover period. Field 515 may indicate a conditional handover period in terms of a CHO period start time, a CHO period periodicity, or a CHO period duration. As shown in FIG. 6, NTN radio network node may determine one or more conditional handover profile indications 610A-610n based on one or more quality of service levels 615A-615n illustrated in table 321. Accordingly, one or more conditional handover profile indications 610 and respectively corresponding conditional handover target node signal strength rank criteria 605, included in field 510/511 of message 320, may be based on, or may correspond to, one or more quality-of-service levels that may be associated with one or more traffic flows that a non-terrestrial radio network node may facilitate with respect to user equipment that receive message 320.

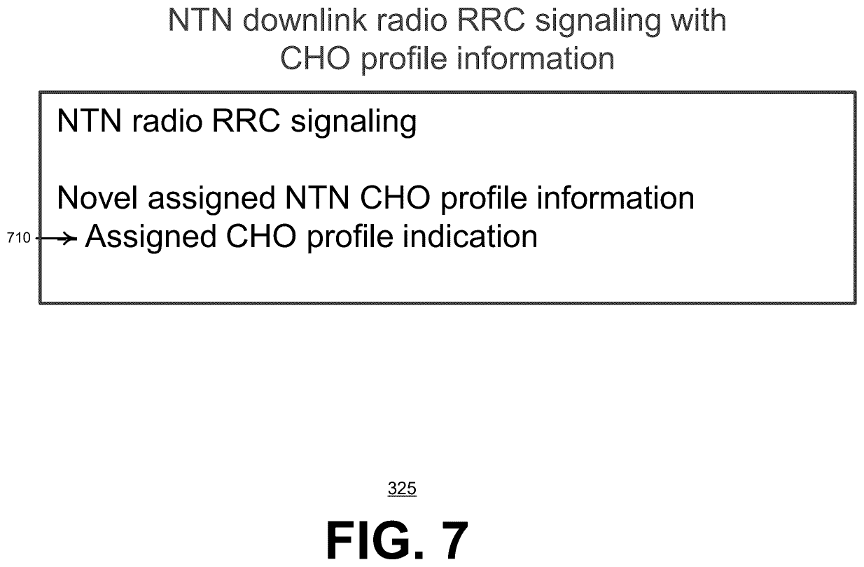

Message 320 may comprise semi-static CHO configuration information usable by active NTN-capable devices 115 after receiving a conditional handover command 330 transmitted by NTN node 107 at act 6. Conditional handover determination configuration information in message 320 may comprise a list of CHO profile indications of TN RAN nodes and respective priority order ranks corresponding thereto. During establishment of a non-terrestrial connection between UE 115 and NTN node 107, to facilitate delivery of traffic 310, NTN node 107 may transmit, at act 4 to UE 115 via CHO profile assignment message 325 shown in FIG. 7, at least one of the at least one conditional handover profile indication listed in message 320 that corresponds to the established non-terrestrial connection. The at least one profile indicated in field 710 of message 325 may be referred to as a connection-based conditional handover profile corresponding to the at least one established non-terrestrial connection established at act 4. Thus, each of multiple UE device 115 that may connect, or have a connection with, NTN node 107 may receive, or may be assigned via a message 325, which may be user-equipment-device-specific, a CHO profile that may correspond to a quality-of-service associated with a requested or already established NTN communication service or communication session. A CHO profile indicated in message 325 may be referred to as an assigned CHO profile indication and may be indicative of an assigned CHO profile.

In an example, a particular CHO profile indication of rank ‘1’ assigned via a first configuration information message 325 to a first NTN-capable user equipment may facilitate the first NTN device being handed over to, or camping on, a best detected TN RAN node (e.g., a terrestrial RAN node with respect to which the first user equipment determines a strongest signal strength compared to signal strength values determined with respect to other TN RAN nodes) when the first user equipment receives a conditional handover command 330, while a second CHO profile indication indicative of a rank ‘2’, assigned via a second configuration information message 325 to a second NTN device in close proximity of the first device, may be indicative that the second NTN user equipment is restricted to being handed over to, or camping on another TN RAN node corresponding to a second best, third best, or even lower ranked signal strength as determined by the second NTN user equipment. Thus, NTN devices in close proximity of one another that receive the same CHO command 330 from the same NTN node 107 may be configured, via different CHO profiles indicated by respectively different messages 325, to be handed over for camping, or for delivery of traffic corresponding to an active communication session, to different TN RAN nodes 105 to avoid overwhelming a single TN RAN node that may correspond to a strongest, or best, signal strength as determined by the different user equipment. Assigning of a profile corresponding to a rank lower than ‘1’ may result in a degradation of performance with respect to a communication session that may be handed over in response to a CHO command 330 due to handing over to a TN RAN node that does not correspond to a best received coverage level. However, because the assigning of profile rank is based on a quality of service (e.g., a lower quality of service requirement may correspond to a lower assigned profile rank/criterion) reasonable performance may be achieved for services that may be associated with ‘best effort’ while a service corresponding to a different user equipment that is associated with a more stringent quality of service requirement may be assigned, via an assignment message 325, a higher rank criterion (e.g., a signal strength order rank of ‘1’). With respect to a communication session corresponding to traffic 310, during connection establishment with an NTN-capable user equipment 115, NTN RAN node 107 may determine a CHO profile rank to be assigned to the user equipment based on requested service and/or quality of service (“QoS”) profile associated with traffic 310. Assignment of a profile may be based on available CHO profiles that have not already been over-scheduled or over-assigned to more user equipment than a profile allocation criterion to prevent overloading a TN RAN node that may be close to many NTN capable user equipment and thus may not correspond to a best signal strength as determined by the user equipment. As shown in FIG. 7, an NTN RAN node may configure a user equipment with a profile ranking criterion via radio resource control connection setup signal message 325, which may include an indication of the determined/assigned CHO profile and thus corresponding CHO timing information that a user equipment that receives a message 325 may retrieve from information received via message 320 that was transmitted by NTN node 107 at act 3.

According to an embodiment, after determining at act 5 that at least one measured energy parameter value satisfies at least one energy saving criterion 410 that may have been configured via configuration information 315 (e.g., an energy consumption rate corresponding to NTN node 107 exceeds a configured energy consumption rate threshold or a configured time slot for triggering group CHO has occurred), an NTN RAN node 107 may determine at least one non-terrestrial downlink beam (e.g., beam 815 shown in FIG. 8) that is/are serving one or more NTN-capable user equipment devices. NTN node 107 may determine the at least one non-terrestrial downlink beam based on at least one energy consumption rate respectively corresponding to the at least one non terrestrial downlink beam such that overall energy consumption at the NTN node drops below a configured energy consumption criterion corresponding to an NTN node energy consumption threshold, or drops below the energy consumption threshold by an energy use margin amount, when a group CHO is performed with respect to user equipment, or with respect to communication session(s) corresponding to user equipment, being served by, or facilitated by, the determined at least one non terrestrial downlink beam. Such conditional handover may be referred to as NES-triggered-beam-specific conditional handover. As shown in FIG. 8, at act 6 (shown in FIG. 3), NTN RAN node 107 may transmit, via beam-specific multicast or groupcast NTN downlink control channel resources that are associated with the at least one determined NTN downlink beam 815, determined at act 5, with respect to which group-conditional-handover is to be implemented, an NES-triggered CHO indication 330, which may be referred to as a conditional handover command, towards one or more NTN devices 115 served by, or camped on, the at least one determined NTN downlink beam.

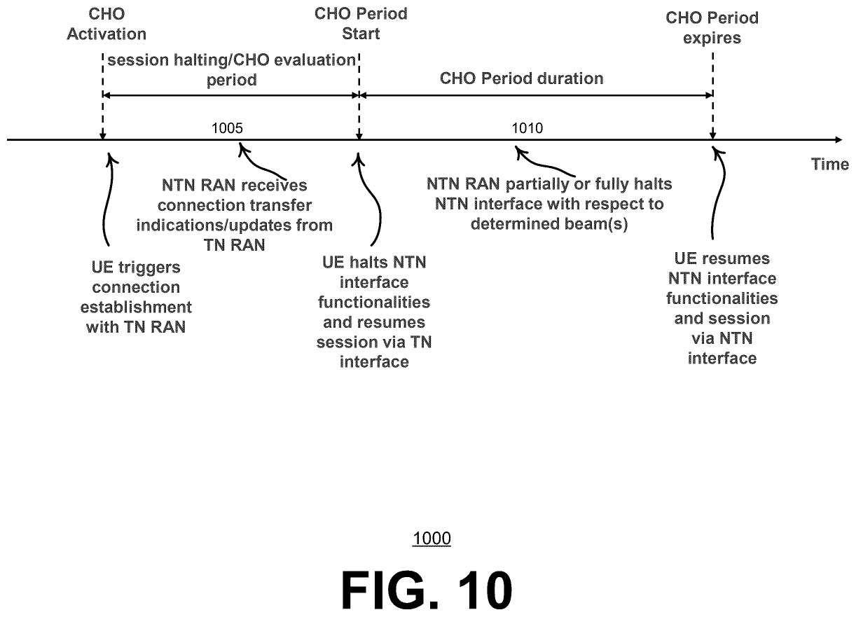

At act 7, NTN RAN node 107 may halt facilitation of at least one active communication session for all NTN user equipment devices served by a determined NTN down link beam 815 (shown in FIG. 8) during a configured session halting period 1005 (shown in FIG. 10), which may be referred to as a conditional handover evaluation period or a conditional handover halting period. Halting period 1005 may be determined based on a number of times a user equipment is expected to attempt to establish a connection with a terrestrial node. During halting period 1005, all session and packet retransmission counters may be halted at NTN node 107 to facilitate one or more user equipment 115, corresponding to a determined downlink beam with respect to which CHO is to be implemented by the NTN node, being determined to be able or unable to successfully connect with a target TN node to facilitate a communication session being conducted with the NTN node being handed over to the target terrestrial radio network node. During halting period 1005, user equipment to be handed over, or user equipment corresponding to communication sessions to be handed over, may be indicated by terrestrial node 105 shown in FIG. 3 to NTN RAN node 107 via at least one connection transfer indication 340 indicative that at least one user equipment corresponding to determined downlink beam 815 has been handed over, or has requested to be handed over, to a target terrestrial radio network node. Failure to receive an indication 340 indicative of at least one user equipment being served by NTN node 107 via determined downlink beam 815 may result in at least one determined non-handed-over user equipment. A user equipment being a non-handed-over user equipment may result from at least one NTN-capable user equipment device 115 that has received a NES-triggered CHO command 330 from NTN RAN node 107 being unable to complete handover to a terrestrial RAN node. An NTN-capable user equipment may be unable to be handed over to a terrestrial radio network node for different reasons.

For example, when an NTN-capable user equipment device is associated with a best effort CHO profile via field 710 in CHO profile assignment message 325 that restricts the user equipment, via a signal strength rank criterion indicated in field 605B of conditional handover determination configuration information 320, to camp on or to be handed over to a terrestrial radio network node corresponding to a third best signal strength as determined by the user equipment, and the third best signal strength does not correspond to a strong enough signal strength, or coverage level, to establish a connection with the terrestrial radio network node corresponding to the third best signal strength, the TN node corresponding to the third best signal may avoid indicating to NTN node 107 that the user equipment has connected, or is attempting to connect, to the TN node for delivery of traffic corresponding to traffic flow(s) 310 during a conditional handover period indicated by command 330. For NTN-capable user equipment that are indicated via an indication message 340 as having been handed over to a terrestrial radio network node, at act 10 non-terrestrial radio network node 107 may indicate to terrestrial radio network node 105, as shown in FIG. 3, via conditional handover session transfer information 345, which may comprise session context corresponding to communication session 310 to be conditionally/temporarily facilitated by the terrestrial radio network node. Terrestrial radio network node 105 may use session context information indicated in message 345 to facilitate delivery at act 11 of traffic 310 to user equipment 115 during conditional handover period 1010. For NTN-capable user equipment that are not indicated via an indication message 340 as having been handed over to a terrestrial radio network node (e.g., the user equipment are non-handed-over user equipment), NTN RAN node 107 may resume facilitation of delivery of traffic 310 to one or more non-handed-over user equipment after halting period 1005 via non-terrestrial resources, thus excluding non-handed-over user equipment from beam-specific conditional handover. After expiration of an activated CHO period 1010, NTN RAN node 107 may at act 12 resume facilitation of delivery of traffic corresponding to traffic flow(s) 310 via non-terrestrial resources and via at least one determined non-terrestrial downlink beam with respect to which conditional handover was implemented during the now-expired conditional handover period 1010. Thus, a conditional handover may be referred to as a time-bound conditional handover, or a temporary handover, insofar as non-terrestrial delivery of traffic corresponding to a handed over user equipment or a handed over communication session may resume at act 12 after conditional handover period 1010 according to resources that were scheduled or used to facilitate delivery of traffic 310 from NTN node 107 to UE 115 at act 2.

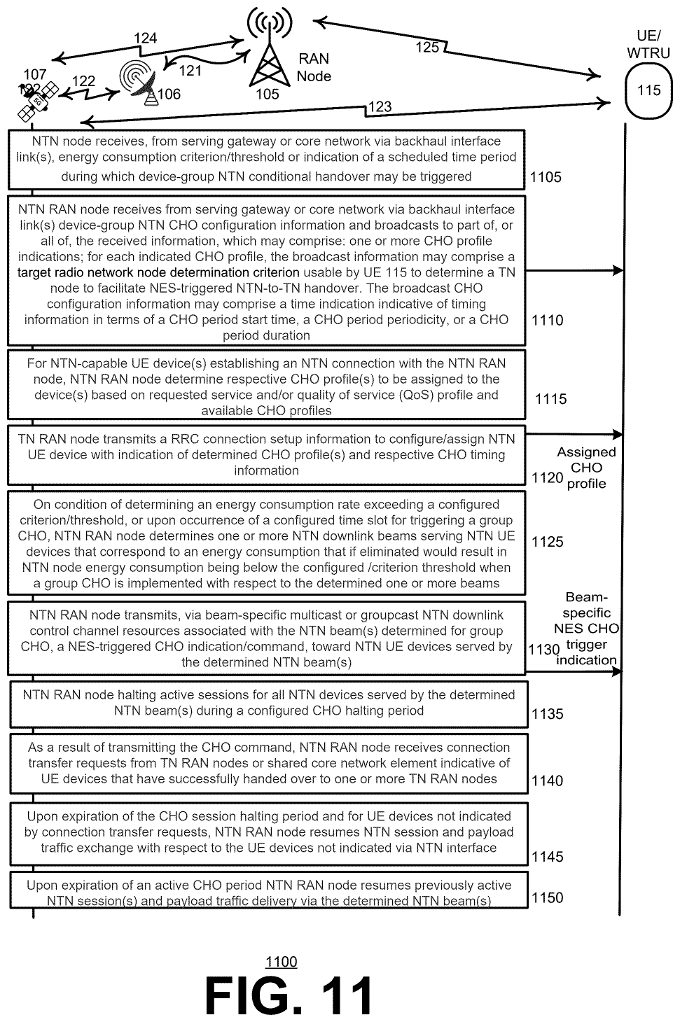

Turning now to FIG. 11, the figure illustrates a timing diagram of an example method 1100. At act 1105, non-terrestrial RAN node/cellular satellite 107 may receive and be configured with energy consumption criterion/criteria (e.g., an energy consumption rate criterion threshold) and/or scheduled time periods during which non-terrestrial traffic handover may be triggered. The energy saving criteria may be directed to NTN node 107 by gateway 106, core network 130, or shared non-terrestrial/terrestrial shared network element 131 via backhaul interface link(s). NTN RAN node 107 may receive, at act 1105 via backhaul interface links, conditional handover configuration information, and may broadcast at act 1110 to NTN-capable user equipment 115 via NTN radio interface links, device-group NTN CHO conditional handover configuration information. The NTN CHO configuration transmitted at act 1110 may comprise at least one conditional handover profile indication indicative of at least one conditional handover target node signal strength rank value. The conditional handover configuration information received at act 1105 may be directed to NTN node 107 by a network entity corresponding to core network 130 or shared network element 131. The conditional handover configuration information may comprise CHO profile information, corresponding to one or more CHO profiles, or one or more CHO profile indications corresponding to one or more CHO profiles. For each indicated CHO profile the conditional handover configuration information may comprise an associated TN RAN node priority order, which may be referred to as a target radio network node determination criterion, to be used by user equipment 115 to determine a terrestrial radio network node to which the user equipment is to attempt to implement network-energy-saving-triggered NTN-to-TN handover. The conditional handover configuration information associated with the CHO profile indications may comprise CHO timing information in terms of CHO start time, CHO periodicity, and CHO duration. A conditional handover profile/profile indication may be associated with at least one quality-of-service. A conditional handover profile indication may be usable by the serving radio network node/NTN node 107 to facilitate indicating, to user equipment 115, a target radio network node determination criterion that is to be usable by the user equipment to determine a radio network node (e.g., TN node 105) with respect to which the user equipment is to attempt handover of a communication session that may be facilitated by the NTN node in response to the at least one handover command transmitted by the NTN node.

At act 1115, user equipment 115 and NTN node 107 may establish a connection to facilitate delivery of traffic corresponding to a communication session. NTN RAN node 107 may determine a CHO profile to be assigned to user equipment 115 based on a requested service and/or a quality-of-service profile associated with the communication session. A CHO profile to be assigned to user equipment 115 may be based on ‘available’ CHO profiles. To avoid over-assigning of a CHO profile, which could result in overloading a particular TN RAN node with traffic during a conditional handover period, a CHO profile may not be available for assigning to user equipment 115 if the same CHO profile has been assigned to other user equipment, or with respect to other communication sessions, in excess of a configured profile assignment criterion. At act 1120, NTN RAN node 107 may transmit, via a radio resource control connection setup signaling message (e.g., profile assignment message 325 shown in FIG. 7), toward NTN-capable user equipment 115 device, that indicates the assigned CHO profile determined at act 1115. The profile assignment message may comprise information indicative of CHO timing.

At act 1125, on condition of determining an energy consumption rate exceeding a configured threshold and/or during configured time slots for triggering group CHO as indicated in information received at act 1105, NTN RAN node 107 may determine one or more NTN downlink beams that are serving one or more NTN-capable user equipment, for example a downlink beam serving UE 115, and that are consuming an amount of energy such that the energy consumption rate at the NTN node would drop below the configured energy consumption threshold if a group conditional handover is performed with respect to the one or more determined downlink beams. At act 1130, NTN RAN node 107 may transmit, via beam-specific multicast or groupcast NTN downlink control channel resources associated with the NTN beam(s) determined for group conditional handover, an NES-triggered CHO indication (e.g., CHO command 330 shown in FIG. 8), toward NTN devices (e.g., UE 115) served by the determined NTN downlink beam(s). At act 1135, NTN RAN node 107 may halt operation with respect to active sessions for all NTN devices served by the determined NTN beam(s), during a configured session halting period (e.g., period 1005), which may be configured with respect to NTN node 107 via configuration information 315 (shown in FIG. 4) received by NTN node at act 1105 or which may be configured with respect to UE 115 via configuration information 320 transmitted by the NTN node at act 1110. The session halting period may be referred to as a conditional handover evaluation period.

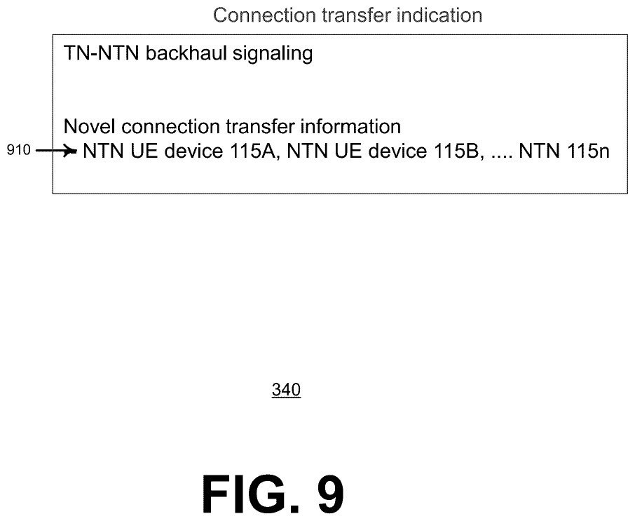

At act 1140, resulting from transmitting a CHO command at act 1130 NTN RAN node 107 may receive a connection transfer indication (e.g., message 340 shown in FIG. 9) directed to the NTN node by TN RAN 105 node or shared core network element 131, indicative of UE 115 being successfully handed over to TN RAN node 105. In an embodiment, on condition of expiration of the session halting period and failure to receive a connection transfer indication indicative of UE 115 being successfully handed over to TN node 105, NTN RAN node 107 may resume the NTN communication session established at act 1115 and continue facilitating payload exchange corresponding to the NTN communication session with UE 115 according to non-terrestrial resources via the determined NTN downlink beam, thus excluding UE 115 from beam-specific CHO. In an embodiment, on condition of expiration of the session halting period and on condition of having received a connection transfer indication indicative of UE 115 being successfully handed over to TN node 105, during a conditional handover period (e.g., period 1010 shown in FIG. 10) indicated in configuration information message 315 or message 320, NTN RAN node 107 may suspend facilitation of the NTN communication session established at act 1115 and may avoid facilitating payload exchange corresponding to the NTN communication session with UE 115. After expiration of the conditional handover period, NTN RAN node 107 may resume the previously active NTN session established at act 1115 with payload delivery with respect to UE 115 corresponding to the communication session via the determined NTN downlink beam and NTN resources.

### Temporary Terrestrial Handover

TN RAN node 105, shown in FIG. 3, may accept, handle, or serve NTN-capable user equipment devices, for example UE 115, performing NTN-to-TN conditional handover during conditional handover period 1010. After expiration of conditional handover period 1010, TN RAN node 105 may proactively switch NTN-capable user device sessions that have been handed over to the TN node back to being facilitated by source NTN RAN node 107 without being triggered by an uplink control signal message received from NTN-capable user equipment device 115. This behavior differs from conventional techniques at least insofar as according to conventional techniques a handover is solely triggered by a handover indication directed toward a target RAN node when a user equipment directs an uplink coverage measurement report to the source RAN node that is indicative of a satisfactory coverage level corresponding to the target RAN node.

Terrestrial RAN node 105 may receive, at act 8, a random-access preamble and uplink connection establishment request 335 from NTN user equipment 115 via uplink TN interface link(s) 125. Request 335 may comprise a conditional handover indication. On condition of a connection establishment service request 335, or a request indication, indicative of a request for temporary NTN-to-TN conditional handover, TN RAN node 105 may determine NTN node 107, with respect to which communication session traffic is to be handed over to the TN node, based on an NTN node identifier indicative of the NTN node that may be part of radio resource control setup request signal message 335. Accordingly, request message 335 may facilitate TN node 105 being informed that a handover being requested by request 335 may be a time-bounded, or a time-limited, (e.g., temporary) handover corresponding to temporary NES mode activation by source NTN RAN node 107.

At act 9, responsive to request message 335, TN RAN node 105 may direct connection transfer request 340 to determined target NTN RAN node 107 directly, or via shared core network element 131 or NTN gateway 106. Connection transfer request 340 may comprise an identifier associated with NTN-capable user equipment device that requested conditional/temporary handover at act 8 via request 335. At act 10, TN RAN node 105 may receive, from NTN RAN node 107, shared core network element 131, or NTN gateway 106 via backhaul interface link(s) 124, 121, or 120, respectively, NTN conditional handover session transfer information 345 in terms of a CHO period start time, a CHO period periodicity, or CHO period duration and conventional, device-specific active session context information (e.g., last delivered packet data convergence protocol (“PDCP”) downlink packet number, last PDCP uplink packet number, QoS profile information corresponding to a communication to be handed over to the TN node, and the like). After receiving session transfer information 345, at act 11 TN RAN node 105 may facilitate delivering of handed over traffic 310 with respect to NTN device 115 via TN interface link(s) 125 during conditional handover period 1010. After expiration of conditional handover period 1010, TN RAN node 105 may proactively compile and direct, at act 12 toward NTN RAN node 107, NTN session update information 350, which may comprise conventional session information corresponding to delivery of traffic 310 during conditional handover period 1010 (e.g., last delivered PDCP downlink packet number, last PDCP uplink packet number, QoS profile info, and the like). At act 13, TN RAN node 105 may flush NTN device context and session information, and at act 14 delivery of traffic 310 may resume being facilitated by NTN node 107.

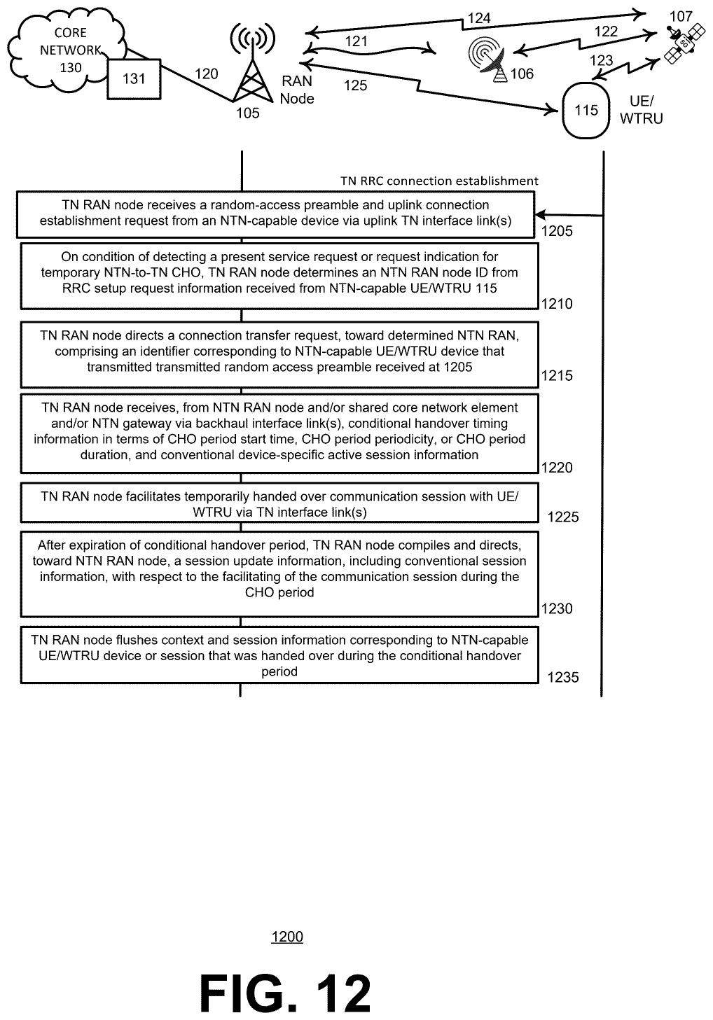

Turning now to FIG. 12, the figure illustrates a timing diagram of an embodiment method 1200. At act 1205, terrestrial RAN node 105 may receive, from NTN-capable user equipment WTRU device 115 via uplink TN interface link(s) 125, a random-access preamble and/or an uplink connection establishment request (e.g., request 335 shown in FIG. 3), which may comprise a conditional handover indication, which may be indicative of a conditional handover period to be implemented by NTN node 107, and which may comprise a request for TN node 105 to facilitate delivery of traffic, during the conditional handover period and with respect to UE 115, that is being facilitated by the NTN node. Responsive to the connection establishment request or based on the conditional handover indication, at act 1210 TN RAN node 105 may identify, or determine an identifier corresponding to, NTN RAN 107 based on a radio resource control setup request signaling message received during connection establishment with UE 115. The identifying of, or determining an identifier corresponding to, NTN node 107 may be based on information included in request 335 or that may be included in a message delivered to TN RAN 105 subsequent to the transmitting of request 335. At act 1215, TN RAN node may transmit to, or direct to (e.g., via gateway 106 or shared network element 131), NTN node 107 a connection transfer request (e.g., request 340 shown in FIG. 3). Connection transfer request 340, which may be referred to as a session transfer request, may comprise an identifier corresponding to UE 115 with respect to which handover may be requested, or with respect to which handover of traffic corresponding to a communication session may be requested, via connection establishment request 335 received at act 1205. At act 1220, responsive to connection/session transfer request 340 (shown in FIG. 3) transmitted at act 1215, TN RAN node 105 may receive, via backhaul interface link(s) from NTN RAN node 107, shared core network element 131, or NTN gateway 106, conditional handover session transfer information (e.g., message 345 shown in FIG. 3). The conditional handover session transfer information may comprise NTN conditional handover timing information associated with conditional handover, that may be indicated by the random-access preamble and/or uplink connection establishment request received at act 1205, in terms of a conditional handover period start time, a conditional handover period periodicity, or a conditional handover period duration. The conditional handover session transfer information received at act 1220 may comprise conventional device-specific active session information (e.g., last delivered PDCP downlink packet number, last PDCP uplink packet number, QoS profile information, etc.). At act 1225, TN RAN node 105 may resume with UE 115, via TN interface link(s) 125 during a conditional handover period indicated by timing information that may be included in conditional handover session transfer information message 345, an NTN communication session, according to session context information that may be included in the conditional handover session transfer information message, that is handed over from NTN node 107 to TN node 105. After expiration of the conditional handover period that may be indicated by timing information included in the conditional handover session transfer information message, at act 1230 TN RAN node 105 may compile and transmit to, or direct to, NTN RAN node 107 an NTN session update information message 350 (shown in FIG. 3). The session update information message may comprise conventional context and session information pertaining to delivering of traffic, by the TN node, during the CHO period (e.g., a last delivered PDCP downlink packet number, a last PDCP uplink packet number, QoS profile information, etc.). At act 1235, after directing the session update information, TN RAN node 105 may flush the context and session information, associated with UE 115, that pertains to the delivering of the NTN traffic, by the TN node to the UE, during the CHO period.

### Time-Based Device Handover Among Non-Terrestrial and Terrestrial Networks.

Returning to description of FIG. 3, NTN-capable user equipment 115 may facilitate handover of communication session traffic 310 from NTN node 107 to TN node 105. After receiving CHO command 330 from NTN RAN node 107, instead of operating according to conventional handover techniques and handing over to a RAN node corresponding to a best received coverage level/signal strength, NTN-capable UE 115 may select a TN RAN node 105 that satisfies a configured order rank criterion received via message 325 at act 4. UE 115 may use an order rank value indicated in field 710 assigned via message 325 to determine a first TN RAN node with which to attempt establishing a connection based on signal strength values, corresponding to one or more TNA RAN nodes, as determined by UE 115. For example, if traffic 310 is associated with a best effort quality of service, an assigned profile may be a 3 or 4. Assigning an order rank lower than 1 may prevent UE 115 from attempting to connect with a TN node corresponding to a strongest signal strength as determined by the UE to avoid the UE consuming resources from the TN node that corresponds to the strongest, or best, signal with respect to the UE so that the resources corresponding to the best signal may be used to facilitate another traffic flow with respect to another UE, which may determine the same TN node as corresponding to a best/strongest coverage level/signal strength, wherein the other traffic flow may be associated with quality of service that is higher than best effort. Thus, if traffic flow 310 being handed over is assigned, via message 325, a profile of 3, UE 115 may first attempt establishing a connection with a TN node corresponding to a third best signal strength, or third best signal, as determined by the UE. In an embodiment, if the UE cannot establish a connection with a TN node corresponding to a determined third best signal strength during halting period 1005 the UE may attempt to establish a connection with a TN node corresponding to a determined fourth best signal strength during the halting period, and so on. In an embodiment, if the UE cannot establish a connection with a third best TN node during halting period 1005, the UE may avoid attempting to establish a connection with another TN node and thus a TN node may not indicate the UE to NTN node 107 via a connection transfer indication 340 and the UE may continue to receive traffic 310 via NTN node 107.

In an embodiment, user equipment with respect to which non-terrestrial traffic flows are conditionally/temporarily handed over from an NTN node to a TN node, the user equipment may, after expiration of conditional handover period 1010, autonomously switch back to receiving NTN traffic 310 via NTN interface link(s) 123 and resume the communication session with NTN node 107 without communication of control channel traffic between the UE and either TN node 105 or NTN node 107. The UE may autonomously revert to receiving traffic 310 after expiration of conditional handover period 1010 because delivery of traffic 310 was handed over due to being triggered by NTN node 107 based on an energy consumption at the NTN node or based on occurrence of configured period instead of being triggered due to poor coverage at the UE with respect to the NTN node.

NTN-capable UE/WTRU 115 may receive, at act 3, NTN configuration information 320 broadcast from NTN RAN node 107 that the user equipment may have selected (e.g., the UE is camped on node 107) or with which the user equipment has established a connection. In reference to FIG. 6, conditional handover determination configuration information 320 may comprise one or more NTN conditional handover profile indications 610 and for each indicated CHO profile an associated priority order rank usable by a user equipment in determining a first TN RAN node with which a user equipment is to attempt to establish a connection after receiving a network-energy-saving-triggered NTN-to-TN handover command 330. Conditional handover determination configuration information 320 may comprise CHO timing information in terms of CHO period start time, CHO period periodicity, and CHO period duration. Conditional handover determination configuration information 320 may comprise semi-static CHO configuration information usable by active NTN-capable user equipment devices. CHO profile indications 610 may indicate a list of available CHO profiles and respective TN RAN node priority order rank criteria, wherein a user equipment attempting to connect to a TN RAN node in response to receiving a CHO command 330 may use an assigned CHO profile to determine, from information in field 510, a rank corresponding to a CHO profile indicated in field 610 that matches the assigned CHO profile, which may be assigned at act 4 via message 325 as described in reference to FIG. 3, wherein the assigned CHO profile may correspond to a quality of service associated with a traffic flow being handed over during a conditional handover period indicated by the conditional handover command 330. The user equipment may attempt to establish a connection with a terrestrial radio network node, of multiple terrestrial radio network nodes with respect to which the user equipment may have determined respective signal strengths/qualities, based on a signal strength rank/criterion corresponding, in conditional handover determination configuration information 320, to a conditional handover profile assigned to the user equipment via message 325 at act 4. For example, a first CHO profile may facilitate a first NTN-capable user equipment camping on, or being handed over to, a TN RAN node corresponding to a best/highest/strongest signal strength/coverage level in response to receiving a CHO command 330 (e.g., the first NTN UE may have been assigned a CHO profile associated with an order priority/rank of ‘1’). A second, different CHO profile associated with a best effort quality of service may be assigned to a second NTN-capable UE device in close proximity to the first NTN UE device. The second CHO profile may restrict the second NTN UE to camping on, or being handed over to, a second or third best TN RAN node (e.g., the assigned second CHO profile may be indicative that the second NTN UE is to attempt to connect with, or camp on, a TN RAN node corresponding to a signal strength rank of 2 or 3 and avoid attempting to camp on or be handed over to a TN node corresponding to a best signal strength/quality). Thus, multiple NTN-capable user equipment devices in close proximity to each other that receive a CHO command 330 from the same NTN node may camp on, or may attempt to establish a connection with, different TN RAN nodes to minimize overwhelming resources corresponding to a single TN RAN node that may correspond to a best signal strength as determined by the multiple user equipment. In the example, the second NTN-capable user equipment device may exhibit a performance degradation due to being handed over to a TN RAN node that does not correspond to a best received coverage level, but such performance degradation may be acceptable for services associated with a best effort quality-of-service, which may be a quality-of service associated with a traffic flow with respect to which an NTN node that is implementing a conditional handover for a conditional handover period is facilitating with respect to the second NTN-capable user equipment.

Message 325 may be delivered to an NTN-capable user equipment during connection establishment with a selected NTN RAN node via a radio resource control connection setup signaling message and may include an indication of an assigned CHO profile and CHO beam-specific downlink control channel information. The NTN-capable user equipment may monitor and blindly decode the CHO control channel associated with a best, currently serving non-terrestrial downlink NTN beam (e.g., the NTN user equipment determines the best non-terrestrial downlink beam based on a signal strength corresponding to the beam). Thus, NTN-capable user equipment may monitor, or ‘listen’, for potential CHO indication commands 330 via a non-terrestrial downlink beam determined, by the user equipment, to be a best beam corresponding to the NTN RAN node.

In an embodiment, after detecting an NES-triggered CHO indication conditional handover command 330, NTN-capable user equipment 115 may determine a TN node order rank, based on conditional handover determination configuration information 320 and an assigned CHO profile 710 shown in FIG. 7. On condition of a TN RAN node corresponding to a first allowed rank corresponding to assigned CHO profile 710 not being able to satisfy conventional coverage conditions (e.g., signal strength not sufficient to facilitate delivery of a traffic flow to be handed over during a conditional handover period), NTN-capable UE 115 may skip implementing of a conditional handover, flush received CHO trigger indication 330, and halt the NTN session corresponding to the traffic flow to be handed over. In an embodiment, if a TN RAN node corresponding to a first allowed rank corresponding to assigned CHO profile 710 cannot satisfy conventional coverage conditions, NTN-capable UE 115 may offset/delay payload delivery, corresponding to a traffic flow to be handed over during a conditional handover period, by a configured or defined CHO session halting period. An NTN-capable user equipment that has received a NES-triggered CHO command 330 from NTN RAN 107 may be unable to complete handover to a TN node interface for multiple reasons. For example, an NTN-capable user equipment may be associated with a best effort CHO profile that restricts the user equipment to camp on, or handover to, a third best TN RAN node based on signal strength measurement determined by the user equipment. If the TN RAN corresponding to the third best signal strength as determined by the NTN-capable user equipment delivers a signal strength/coverage level to the NTN-capable user equipment that is too poor/weak to facilitate connection establishment, the user equipment may determine that the currently selected NTN RAN node that triggered the CHO and transmitted the CHO command 330 may halt, but not terminate, the user equipment's NTN session for a configured or defined CHO session halting period (e.g., period 1005 shown in FIG. 10) until the NTN node determines, for example by failing to receive a connection transfer indication message 340 during the configured halting period, that conditional handover with respect to the NTN user equipment could not be completed. Failure to receive, by the NTN node, an indication of at least one user equipment via a connection transfer indication message 340 during the configured halting period 1005 may result in the NTN avoiding implementing of conditional handover with respect to at least one user equipment not indicated by a connection transfer indication message 340 during the configured halting period as being successfully handed over, or as being associated with a traffic flow that has been successfully handed over, and the NTN node may resume, during a conditional handover period 1010, a session corresponding to user equipment not handed over during halting period 1005, via a non-terrestrial interface and via non-terrestrial resource. Thus, an NTN-capable user equipment that fails to establish a connection with a TN node to facilitate conditional handover of traffic during halting period 1005 may also adopt configured or defined CHO session halting period 1005 and may avoid attempting delivering of the traffic corresponding to a not-handed-over communication session via the NTN node until the NTN RAN node resumes facilitation of delivering of traffic with respect to the NTN user equipment, via non-terrestrial resources, after expiration of the halting period (e.g., during conditional handover period 1010) even if the NTN node has suspended facilitation of delivering of traffic during the conditional handover period with respect to other NTN-capable user equipment that were able to establish a connection with a terrestrial radio network node that is facilitating delivery of traffic to the other user equipment on behalf of the non-terrestrial radio network node during the conditional handover period.

In an embodiment, on condition of a TN node corresponding to a signal strength rank, as determined by a NTN-capable user equipment, that is associated with profile 710 assigned to the user equipment, and that satisfies conventional coverage criteria for establishing a handover, the NTN-capable user equipment may detach from an non-terrestrial interface corresponding to an NTN node that the user equipment has camped on or that is facilitating delivery of traffic to the user equipment, and may attempt random access with respect to the first allowed TN node (e.g., a TN node having a determined signal strength/quality that corresponds to an assigned conditional handover profile) to facilitate conditional handover. The NTN-capable user equipment may transmit uplink connection establishment requests, (e.g., request 335 shown in FIG. 3) toward first allowed TN node 105 to facilitate conditional handover. Message 335 may comprise a conditional handover service request indication indicative of a request for conditional handover of a traffic flow that is being facilitated by an NTN node. Message 335 may comprise an indication, or identifier, of the NTN RAN node that is facilitating the traffic flow to be handed over during a conditional handover period. The conditional handover service request indication may be indicative to the TN node that handover of traffic with respect to the user equipment is to be time-bounded, or temporary, and may be indicative that the conditional handover being requested may be due to temporary NES mode activation at the source NTN RAN node.

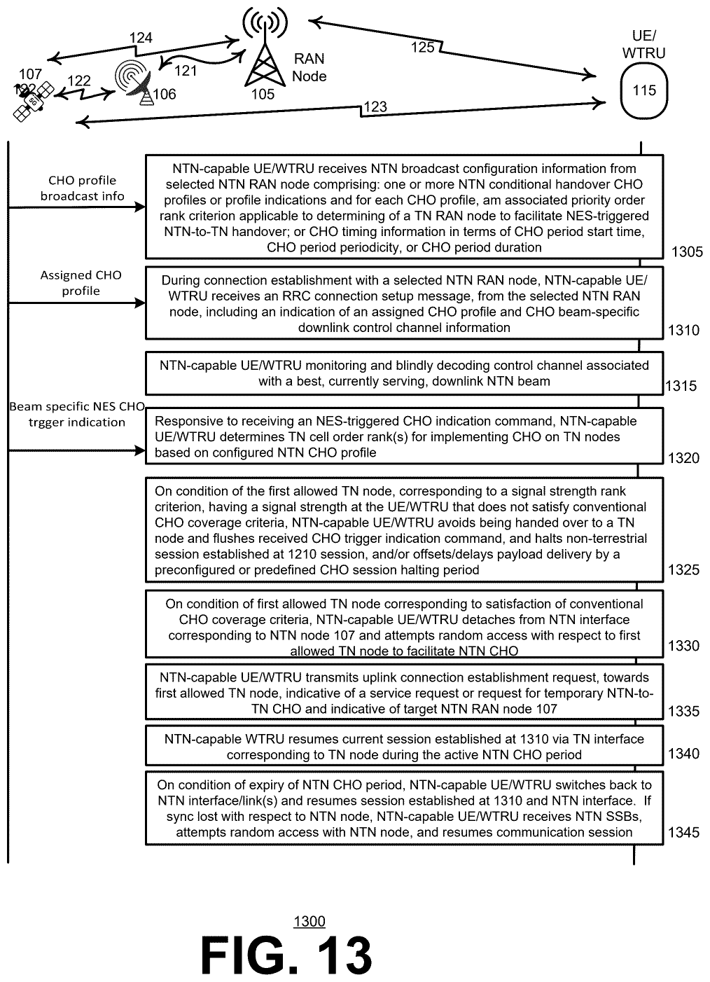

Turning now to FIG. 13, the figure illustrates a timing diagram of an example method embodiment 1300. At act 1305, non-terrestrial-network-capable user equipment 115 may receive NTN information broadcast by NTN RAN node 107 that the UE has selected. The information broadcast by NTN node 107 may comprise message 320 shown in FIG. 3 and may be referred to as conditional handover determination configuration information, or conditional handover configuration information. The conditional handover determination configuration information may comprise information regarding one or more NTN conditional handover CHO profiles, or one or more conditional handover profile indications indicative thereof. For each indicated CHO profile, the conditional handover determination configuration information may comprise one or more priority order ranks respectively associated with the one or more conditional profile indications. The one or more priority order ranks, which may be referred to as conditional handover target node signal strength rank criteria, may be usable by UE 115 to determine a first TN RAN node with which to attempt to establish a connection to facilitate delivery of NTN traffic that is being facilitated by NTN node 107, and that may be conditionally handed over, or temporarily offloaded, to being facilitated by a terrestrial radio network node during a conditional handover period that may be triggered by NTN node 107 based on a measured energy consumption value satisfying a network energy saving energy consumption criterion. The conditional handover determination configuration information may comprise CHO timing information in terms of a CHO period start time, a CHO periodicity, or a CHO period duration.

At act 1310, during connection establishment with NTN RAN node 107 to facilitate delivery of NTN traffic corresponding to a communication session, NTN-capable UE/WTRU 115 may receive a radio resource control connection setup signaling message from NTN RAN node 107, for example profile assignment message 325 shown in FIG. 7. Profile assignment message 325 may comprise an indication of an assigned conditional handover profile that is based on a quality of service corresponding to the communication session established at act 1310. A conditional handover profile to be assigned via message 325 may be determined by NTN node 107, by a network element of core network 130, or by a shared core network element 131. In addition to comprising an indication of an assigned CHO profile, profile assignment message 325 may comprise an indication of CHO beam-specific downlink control channel information. At act 1315, NTN-capable UE/WTRU may monitor and blindly decode the CHO control channel, associated with a best beam (as determined by the UE/WTRU based on signal strength), or associated with a currently serving downlink NTN beam. Responsive to detecting, as a result of the monitoring and decoding at act 1315, an NES-triggered CHO indication command (e.g., conditional handover command 330 shown in FIG. 8), at act 1320 NTN-capable UE/WTRU may determine TN node 105 as a first terrestrial node to attempt to establish a connection with based on a conditional handover target node signal strength rank criterion in conditional handover determination configuration information 320, received at act 1305, that corresponds to a assigned conditional handover profile assigned via profile assignment message 325 (e.g., the UE may determine as a first TN node, with which to attempt connection establishment in response to message 330, a TN node that corresponds to a third best signal strength, a fourth best signal strength, a fifth best signal strength, etc., according to the conditional handover target node signal strength rank criterion that may be, respectively, a 3, a 4, a 5, or higher).

In an embodiment, on condition of a conventional coverage/signal strength criterion corresponding to a TN node with which NTN-capable UE/WTRU 115 first attempts connection establishment not being satisfied, at act 1325, the UE may skip conditional handover operation with respect to session payload delivery associated with the NTN session set up at act 1310, flush the received CHO trigger indication/command message 330, and halt the NTN session, or offset/delay payload delivery associated with the communication session by a configured or defined CHO session halting period (e.g., period 1005 shown in FIG. 10). (In an embodiment, NTN node 107 does not facilitate delivery of the communication session during halting period 1005.)

In an embodiment, on condition of a conventional coverage/signal strength criterion corresponding to a TN node with which NTN-capable UE/WTRU 115 first attempts connection establishment not being satisfied, the UE may attempt connection establishment with another terrestrial radio network node corresponding to a next best signal strength. For example, if a conditional handover target node signal strength rank criterion corresponding to an assigned conditional handover profile assigned by an assignment message 325 with respect to a particular communication session is indicated in conditional handover determination configuration information 320 as a signal strength rank of ‘3’, in response to a conditional handover command 330 UE 115 may first attempt to establish a connection with a terrestrial radio network node corresponding to a third best signal strength with respect to other terrestrial radio network nodes for which the UE can determine reference signal strength measurements. If user equipment 115 cannot establish a connection with the third best terrestrial radio network node according to conventional handover criteria, the user equipment may attempt to establish a connection with terrestrial radio network node corresponding to a fourth best reference signal strength measurement. Although success in establishing a connection with a terrestrial radio network node corresponding to a fourth best reference signal strength measurement after failure to successfully establish a connection with a terrestrial radio network node corresponding to a third best reference signal strength is unlikely because successful connection establishment with a terrestrial node corresponding to a fourth best signal strength is less likely than successful connection establishment with a terrestrial node corresponding to a third best signal strength, user equipment 115 may nevertheless be configured to attempt connection with a terrestrial radio network node corresponding to a signal strength that is less than a signal strength rank corresponding to a conditional handover profile assigned by an assignment message 325.

In an embodiment, on condition of a first terrestrial radio network node (e.g., TN node 105) being determined to correspond to a reference signal strength measurement, as determined by NTN-capable user equipment 115, that satisfies a signal strength rank corresponding to a conditional handover profile assigned by an assignment message 325 received by the user equipment at act 1310, wherein the user equipment successfully establishes a connection with TN node 105 according to conventional coverage condition criteria, at act 1330 the NTN-capable UE/WTRU may detach from the NTN interface via link(s) 123 and may attempt random access with TN node 105 via link(s) 125. At act 1335, NTN-capable UE/WTRU may transmit an uplink connection establishment request (e.g., message 335), toward TN node 105, indicative of a service request, or indicative of a request for temporary NTN-to-TN conditional handover with respect to the communication session set up at act 1310. The uplink connection establishment request transmitted at act 1335 may be indicative of NTN RAN node 107. At act 1340, NTN-capable UE/WTRU 115 may resume the communication session set up at act 1310 via TN interface link (a) 125 during a conditional handover period indicated by timing information that may have been included in the broadcast information received via message 320 at act 1305. After, or upon, expiration of the conditional handover period (e.g., period 1010 shown in FIG. 10), at act 1340 NTN-capable UE/WTRU 115 may switch back to an NTN interface corresponding to NTN node 107 and resume the communication set up at act 1310 via NTN interface link(s) 123. If synchronization between UE 115 and NTN node is lost during conditional handover period 1010, UE 115 may read non-terrestrial synchronization signal block signal message broadcast by NTN node 107, perform random access with NTN node 107, and resume the communication session, established at act 1310, with NTN node 107. Thus, according to one or more acts described in reference to FIG. 13, after the expiration of conditional handover period 1010, UE 115 may perform a time-based handover back to non-terrestrial radio network node 107.

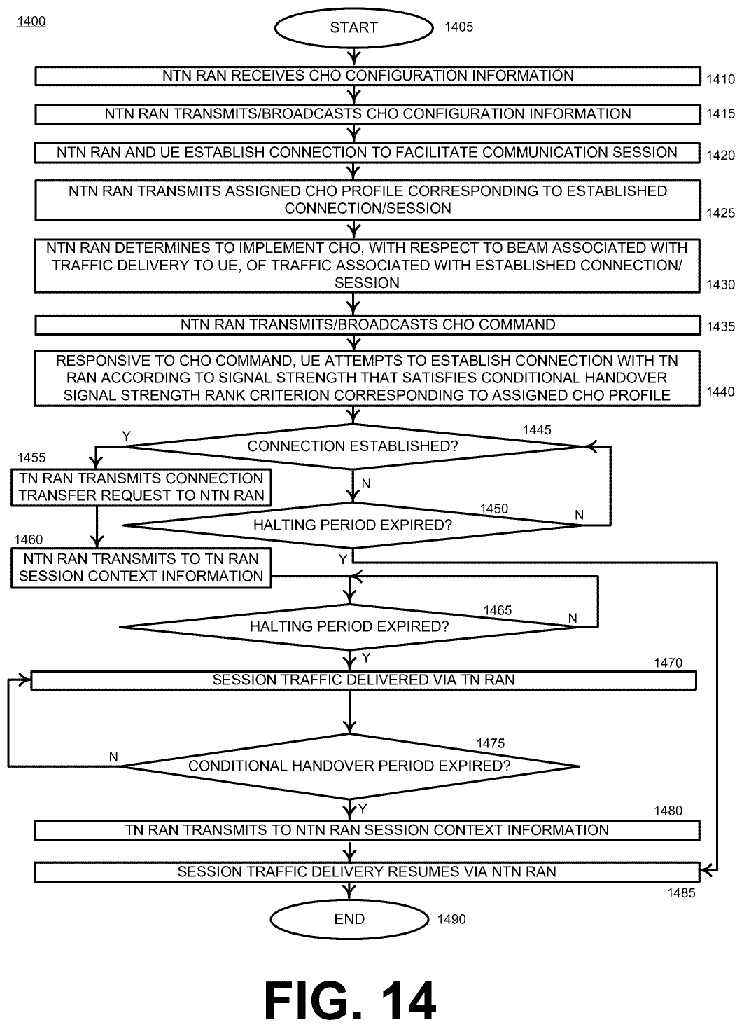

Turning now to FIG. 14, the figure illustrates a flow diagram of an example method 1400. Method 1400 begins at act 1405. At act 1410, a non-terrestrial radio network node may receive conditional handover configuration information. The conditional handover configuration information may be received via message 315 described in reference to FIGS. 3 and 4. The conditional handover configuration information may be directed to the non-terrestrial radio network node by a core network element or a shared core network element and may be transmitted to the non-terrestrial radio network node via a terrestrial radio network node or via a not terrestrial network gateway such as gateway 106 shown in FIG. 2. Continuing with description of FIG. 14, the conditional handover configuration information received at act 1410 may comprise at least one energy related criterion, for example, an energy consumption criterion such as an energy consumption threshold. The conditional handover configuration information received at act 1410 may comprise timing information indicative of a conditional handover period and at least one conditional handover profile indication.

At act 1415, the non-terrestrial radio network node may transmit, or broadcast, conditional handover configuration information to be receivable by at least one user equipment. The conditional handover configuration information transmitted or broadcast at act 1415 may comprise conditional handover configuration information received by the non-terrestrial radio network node at act 1410. At act 1420, the non-terrestrial radio network node and a user equipment may establish a connection to facilitate delivery of traffic with respect to the user equipment corresponding to a communication session. During connection establishment at act 1420, at act 1425 the non-terrestrial radio network node may transmit an assigned conditional handover profile indication associated with a conditional handover profile assigned by the non-terrestrial radio network node to the connection being established, or to the session being set up, at act 1420. The assigned conditional handover profile indication transmitted at act 1425 may correspond to one of multiple conditional handover profiles indications indicated in conditional handover configuration information received by the non-terrestrial radio network node at 1410 or the assigned conditional handover profile indication may be one of multiple conditional handover profiles indicated in conditional handover configuration information transmitted by the non-terrestrial radio network node at act 1415.

At act 1430, the non-terrestrial radio network node may determine to implement a conditional handover of delivery of traffic with respect to at least one beam corresponding to the non-terrestrial radio network node. The non-terrestrial radio network node may determine to implement conditional handover, according to a network energy saving mode operation, based on an energy consumption rate satisfying an energy consumption criterion received by the non-terrestrial radio network node at act 1410. It will be appreciated that the energy consumption criterion, timing information indicative of a conditional handover period, or conditional handover profile indications may be received at act 1410 by the non-terrestrial radio network node via separate messages or via a single message. The at least one beam with respect to which the non-terrestrial radio network node may determine to implement conditional handover may correspond to at least one user equipment and may be used to facilitate delivering of traffic corresponding to the connection/session established at act 1420. At act 1435, the non-terrestrial radio network node may transmit, or broadcast, a conditional handover command, for example command 330 shown in FIG. 3. A user equipment may receive the conditional handover command transmitted by the non-terrestrial radio network node via the beam with respect to which the not terrestrial radio network node has determined to implement conditional handover as a result of determining to implement a network energy saving mode based on a measured energy consumption value satisfying an energy consumption criterion that may have been received by the non-terrestrial radio network node at act 1410. Responsive to receiving the conditional handover command, at act 1440 the user equipment may attempt to establish a connection with a terrestrial radio network node. The user equipment may attempt to establish the connection at act 1440 according to at least one signal strength corresponding to at least one terrestrial radio network node wherein the user equipment measures the at least one signal strength. The user equipment may ascertain, or determine, more than one signal strength respectively corresponding to more than one terrestrial radio network node. The user equipment may determine a target terrestrial radio network node with which to attempt connection establishment at act 1440 based on a measured signal strength corresponding to the target terrestrial radio node and according to a signal strength rank criterion that is configured via conditional handover configuration information transmitted by the non-terrestrial radio network node at 1415 and that is associated therein with a conditional handover profile indication that matches the assigned conditional handover profile indication transmitted to the user equipment at act 1425. A connection between the user equipment and the terrestrial radio network node may or may not be established as a result of the attempt by the user equipment to establish a connection at act 1440. Failure to establish a connection at act 1440 may result from a signal strength corresponding to the target terrestrial radio network node failing to facilitate, or failing to support, at least one conventional handover criterion.

If a connection between the user equipment and the target terrestrial radio network node is not established as a result of a connection establishment attempt at act 1440, method 1400 advances to act 1450. At act 1450, if a configured session halting period has not expired, method 1400 returns to act 1445. A session halting period, for example halting period 1005 shown in FIG. 10, may be configured in the user equipment via conditional handover configuration information transmitted by the non-terrestrial radio network node at act 1415. A session halting period may be configured in the non-terrestrial radio network node via conditional handover configuration information received by the non-terrestrial radio network node at act 1410. If, at act 1450, a configured session halting period has expired, because a connection responsive to the conditional handover command transmitted at act 1435 was not successfully established between the user equipment and the target terrestrial radio network node at act 1440 the non-terrestrial radio network node and the user equipment may, at act 1485, continue facilitation of delivery of traffic, corresponding to the communication session set up at act 1420, via non-terrestrial interface links during a conditional handover period configured via conditional handover configuration information transmitted by the non-terrestrial radio network node at act 1415. The facilitation, at act 1485, during the conditional handover period may be facilitated by the beam with respect to which the non-terrestrial radio network node determined, at act 1430, to implement a network energy saving operation mode that comprises partial conditional handover (e.g., communication sessions with respect to user equipment that are successfully handed over to a terrestrial radio network node are suspended by the non-terrestrial radio network node during a configured conditional handover period).

To accommodate a full network energy saving mode with respect to the beam associated with delivery of traffic corresponding to the communication session set up at act 1420, in an embodiment, at act 1485 the user equipment may delay, or offset, facilitation of delivery of traffic corresponding to the communication session set up at act 1420 during a configured conditional handover period, which may have been configured via conditional handover configuration information transmitted by the non-terrestrial radio network node, and received by the user equipment, at act 1415. Method 1400 may advance from act 1485 to act 1490 and end.

Returning to description of act 1445, if, responsive to a conditional handover command transmitted by the non-terrestrial radio network node at act 1435, a connection between the user equipment and a target terrestrial radio network node is established as a result of a connection establishment attempt at act 1440, method 1400 advances to act 1455. At act 1455, the target terrestrial radio network node may transmit a connection transfer request to the non-terrestrial radio network node that transmitted the conditional handover command at act 1435. The target terrestrial radio network node may have received an identifier indicative of the non-terrestrial radio network node that transmitted the conditional handover commanded at act 1435 via a message (e.g., message 335 shown in FIG. 3) transmitted by the user equipment to the target terrestrial radio network node at act 1455. Accordingly, the target terrestrial radio network node may, at act 1455, direct the connection transfer request to a non-terrestrial radio network node indicated to the terrestrial radio network node by the user equipment at act 1440.

Responsive to the connection transfer request, the non-terrestrial radio network node may transmit, at act 1460, to the target terrestrial radio network node, conditional handover session transfer information (e.g., message 345 shown in FIG. 3). The conditional handover session transfer information may comprise conditional handover timing information, associated with the conditional handover indicated to the user equipment at act 1435, in terms of a conditional handover period start time, a conditional handover period periodicity, or a conditional handover period duration. The conditional handover session transfer information may comprise conventional device-specific active session context information (e.g., last delivered PDCP downlink packet number, last PDCP uplink packet number, QoS profile information, etc.). At act 1465, a determination may be made whether a session halting period 1005 has expired. After the session halting period expires at act 1465, at act 1470 delivery of traffic corresponding to the communications session set up at act 1420 may be facilitated by the target terrestrial radio network node according to terrestrial resources via terrestrial radio links and according to session context information transmitted by the non-terrestrial radio network node to the target terrestrial radio network node at act 1460. Delivery of traffic at act 1470 may continue until expiration at act 1475 of a conditional handover period indicated by conditional handover configuration information transmitted by the non-terrestrial radio network node at act 1415. After expiration at act 1475 of the conditional handover period, the target terrestrial radio network node may transmit, at act 1480, updated session context information to the non-terrestrial radio network node that handed over the communication session delivered by the target terrestrial radio network node at act 1470. The updated session context information transmitted by the target terrestrial radio network node to the non-terrestrial radio network node at act 1480 may correspond to delivery of the traffic that was conditionally, or temporarily, handed over from the non-terrestrial radio network node to the target terrestrial radio network node and that was delivered via the target terrestrial radio network node at act 1470. After the target terrestrial radio network node transmits the updated session context information to the non-terrestrial radio network node at act 1480, the non-terrestrial radio network node may at act 1485 resume delivery of traffic that was facilitated during the conditional handover period by the target terrestrial radio network node. Method 1400 advances from act 1485 to act 1490 and ends.

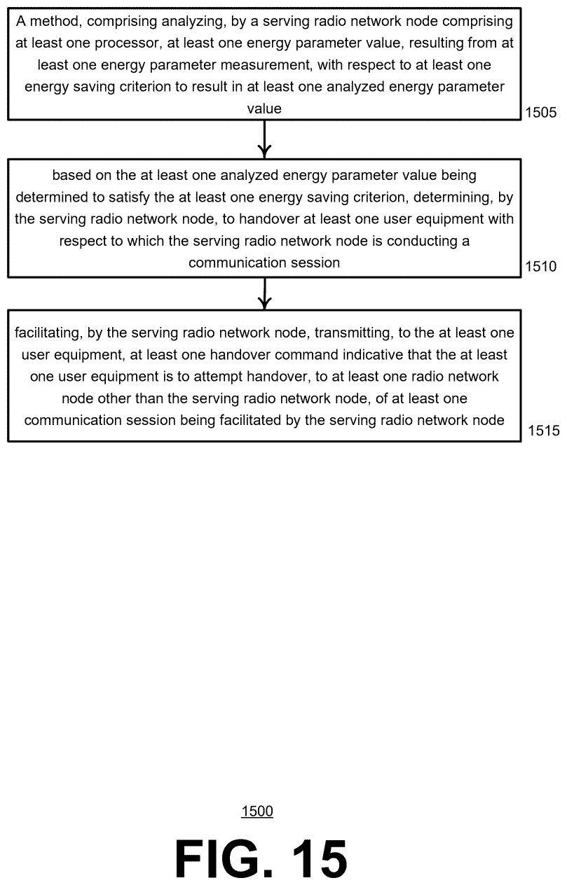

Turning now to FIG. 15, the figure illustrates an example embodiment method 1500 comprising at block 1505 analyzing, by a serving radio network node comprising at least one processor, at least one energy parameter value, resulting from at least one energy parameter measurement, with respect to at least one energy saving criterion to result in at least one analyzed energy parameter value; at block 1510 based on the at least one analyzed energy parameter value being determined to satisfy the at least one energy saving criterion, determining, by the serving radio network node, to handover at least one user equipment with respect to which the serving radio network node is conducting a communication session; and at block 1515 facilitating, by the serving radio network node, transmitting, to the at least one user equipment, at least one handover command indicative that the at least one user equipment is to attempt handover, to at least one radio network node other than the serving radio network node, of at least one communication session being facilitated by the serving radio network node.

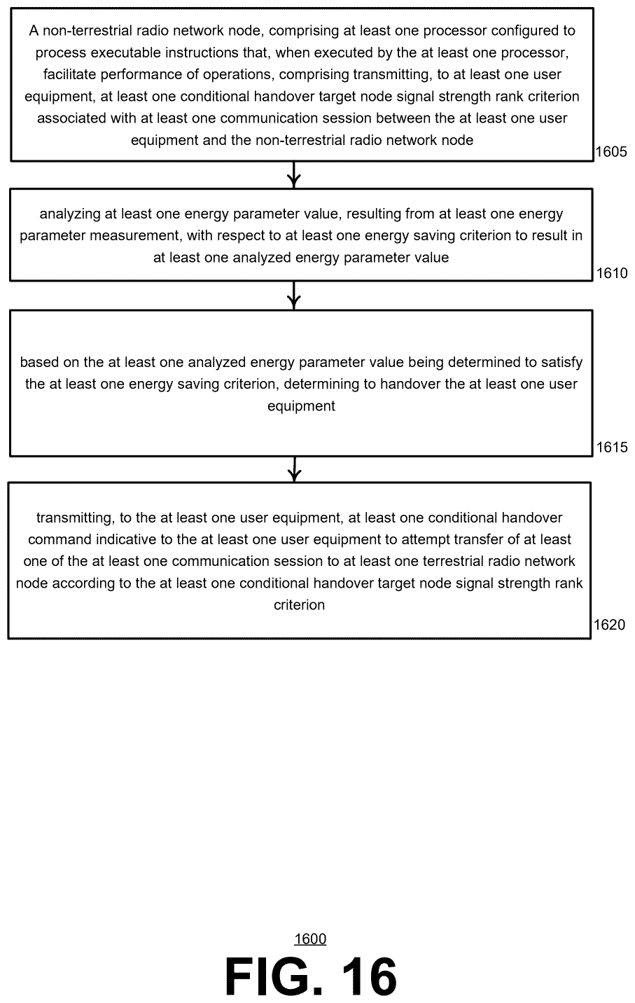

Turning now to FIG. 16, the figure illustrates a non-terrestrial radio network node 1600, comprising at block 1605 at least one processor configured to process executable instructions that, when executed by the at least one processor, facilitate performance of operations, comprising transmitting, to at least one user equipment, at least one conditional handover target node signal strength rank criterion associated with at least one communication session between the at least one user equipment and the non-terrestrial radio network node; at block 1610 analyzing at least one energy parameter value, resulting from at least one energy parameter measurement, with respect to at least one energy saving criterion to result in at least one analyzed energy parameter value; at block 1615 based on the at least one analyzed energy parameter value being determined to satisfy the at least one energy saving criterion, determining to handover the at least one user equipment; and at block 1620 transmitting, to the at least one user equipment, at least one conditional handover command indicative to the at least one user equipment to attempt transfer of at least one of the at least one communication session to at least one terrestrial radio network node according to the at least one conditional handover target node signal strength rank criterion.

Turning now to FIG. 17 the figure illustrates a non-transitory machine-readable medium 1700 comprising at block 1705 executable instructions that, when executed by at least one processor of a terrestrial radio network node, facilitate performance of operations, comprising transmitting, to at least one user equipment, conditional handover determination configuration information comprising at least one conditional handover profile indication indicative of at least one conditional handover target node signal strength rank value; at block 1710 establishing, with the at least one user equipment, a non-terrestrial connection to result in at least one established non-terrestrial connection, wherein the establishing of the at least one established non-terrestrial connection comprises transmitting, to the at least one user equipment, at least one of the at least one conditional handover profile indication corresponding to the at least one established non-terrestrial connection to result in at least one connection-based conditional handover profile corresponding to the at least one established non-terrestrial connection; at block 1715 analyzing at least one energy parameter value, resulting from at least one energy parameter measurement, with respect to at least one energy saving criterion to result in at least one analyzed energy parameter value; at block 1720 based on the at least one analyzed energy parameter value being determined to satisfy the at least one energy saving criterion, determining to handover the at least one user equipment; and at block 1725 transmitting, to the at least one user equipment, at least one handover command indicative to the at least one user equipment to attempt handover to at least one terrestrial radio network node according to at least one of the at least one conditional handover target node signal strength rank value corresponding to the at least one connection-based conditional handover profile.

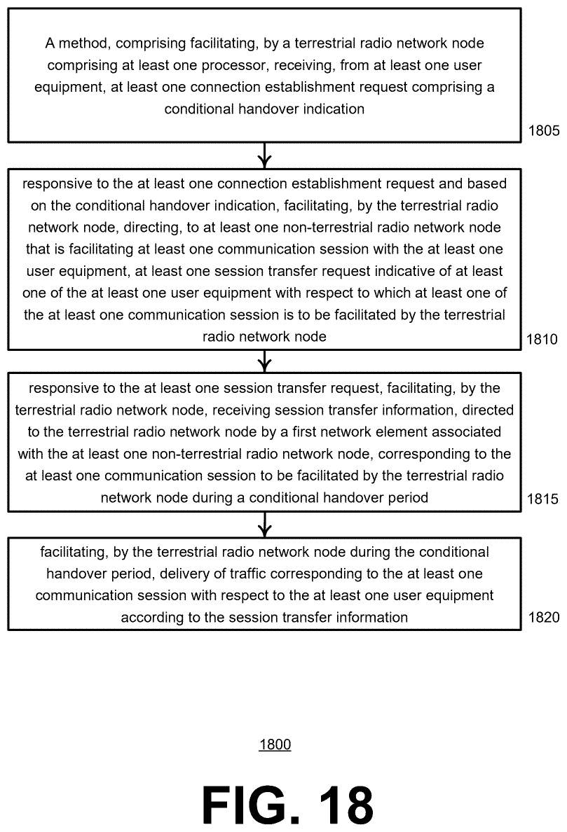

Turning now to FIG. 18, the figure illustrates an example embodiment method 1800 comprising, at block 1805, facilitating, by a terrestrial radio network node comprising at least one processor, receiving, from at least one user equipment, at least one connection establishment request comprising a conditional handover indication; at block 1810 responsive to the at least one connection establishment request and based on the conditional handover indication, facilitating, by the terrestrial radio network node, directing, to at least one non-terrestrial radio network node that is facilitating at least one communication session with the at least one user equipment, at least one session transfer request indicative of at least one of the at least one user equipment with respect to which at least one of the at least one communication session is to be facilitated by the terrestrial radio network node; at block 1815 responsive to the at least one session transfer request, facilitating, by the terrestrial radio network node, receiving session transfer information, directed to the terrestrial radio network node by a first network element associated with the at least one non-terrestrial radio network node, corresponding to the at least one communication session to be facilitated by the terrestrial radio network node during a conditional handover period; and at block 1820 facilitating, by the terrestrial radio network node during the conditional handover period, delivery of traffic corresponding to the at least one communication session with respect to the at least one user equipment according to the session transfer information.

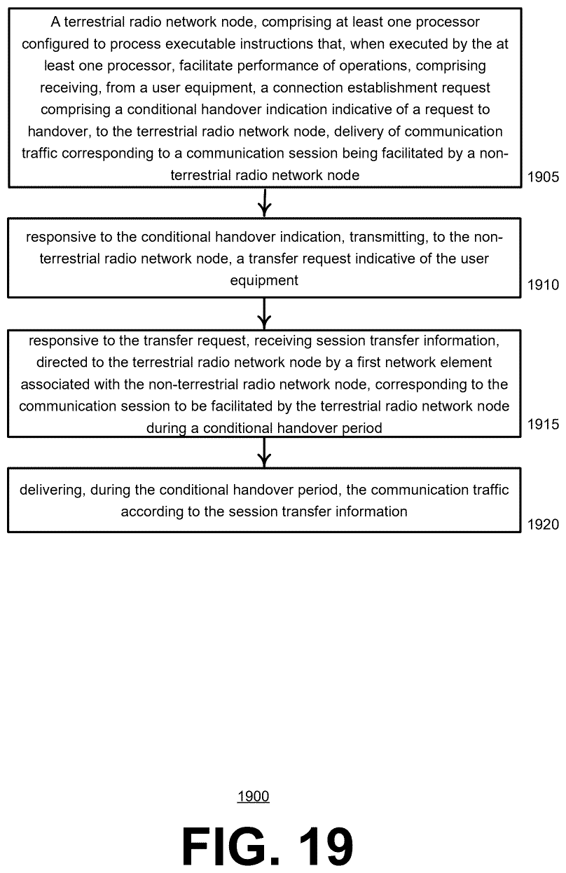

Turning now to FIG. 19, the figure illustrates an example terrestrial radio network node 1900, comprising at block 1905 at least one processor configured to process executable instructions that, when executed by the at least one processor, facilitate performance of operations comprising receiving, from a user equipment, a connection establishment request comprising a conditional handover indication indicative of a request to handover, to the terrestrial radio network node, delivery of communication traffic corresponding to a communication session being facilitated by a non-terrestrial radio network node; at block 1910 responsive to the conditional handover indication, transmitting, to the non-terrestrial radio network node, a transfer request indicative of the user equipment; at block 1915 responsive to the transfer request, receiving session transfer information, directed to the terrestrial radio network node by a first network element associated with the non-terrestrial radio network node, corresponding to the communication session to be facilitated by the terrestrial radio network node during a conditional handover period; and at block 1920 delivering, during the conditional handover period, the communication traffic according to the session transfer information.

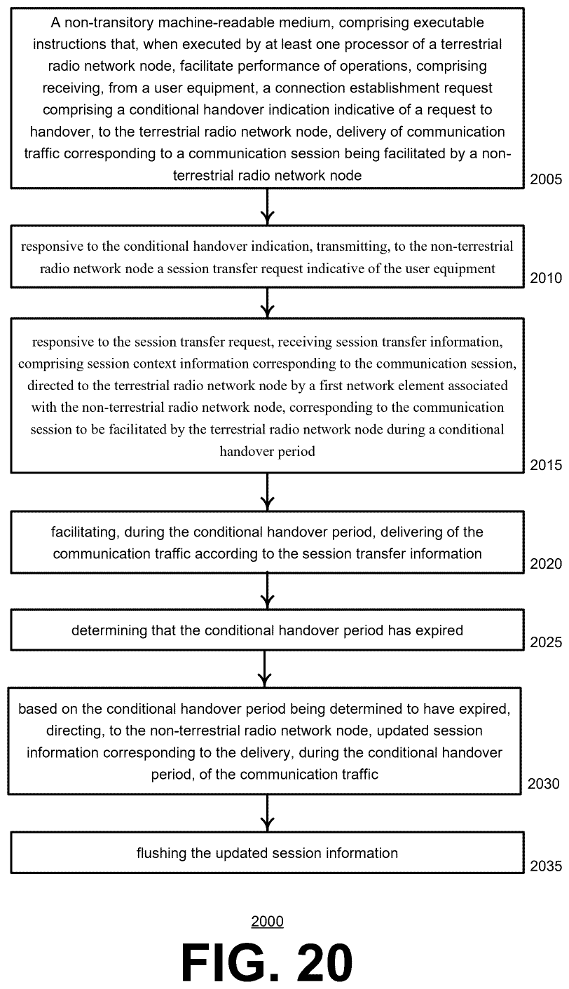

Turning now to FIG. 20, the figure illustrates a non-transitory machine-readable medium 2000 comprising at block 2005 executable instructions that, when executed by at least one processor of a terrestrial radio network node, facilitate performance of operations, comprising receiving, from a user equipment, a connection establishment request comprising a conditional handover indication indicative of a request to handover, to the terrestrial radio network node, delivery of communication traffic corresponding to a communication session being facilitated by a non-terrestrial radio network node; at block 2010 responsive to the conditional handover indication, transmitting, to the non-terrestrial radio network node a session transfer request indicative of the user equipment; at block 2015 responsive to the session transfer request, receiving session transfer information, comprising session context information corresponding to the communication session, directed to the terrestrial radio network node by a first network element associated with the non-terrestrial radio network node, corresponding to the communication session to be facilitated by the terrestrial radio network node during a conditional handover period; at block 2020 facilitating, during the conditional handover period, delivering of the communication traffic according to the session transfer information; at block 2025 determining that the conditional handover period has expired; at block 2030 based on the conditional handover period being determined to have expired, directing, to the non-terrestrial radio network node, updated session information corresponding to the delivery, during the conditional handover period, of the communication traffic; and at block 2035 flushing the updated session information.

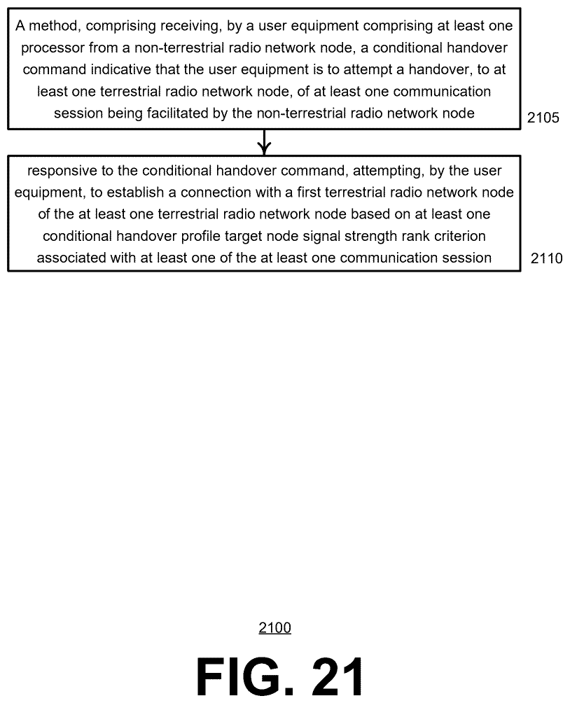

Turning now to FIG. 21, the figure illustrates an example embodiment method 2100 comprising, at block 2105, receiving, by a user equipment comprising at least one processor from a non-terrestrial radio network node, a conditional handover command indicative that the user equipment is to attempt a handover, to at least one terrestrial radio network node, of at least one communication session being facilitated by the non-terrestrial radio network node; and at block 2010 responsive to the conditional handover command, attempting, by the user equipment, to establish a connection with a first terrestrial radio network node of the at least one terrestrial radio network node based on at least one conditional handover profile target node signal strength rank criterion associated with at least one of the at least one communication session.

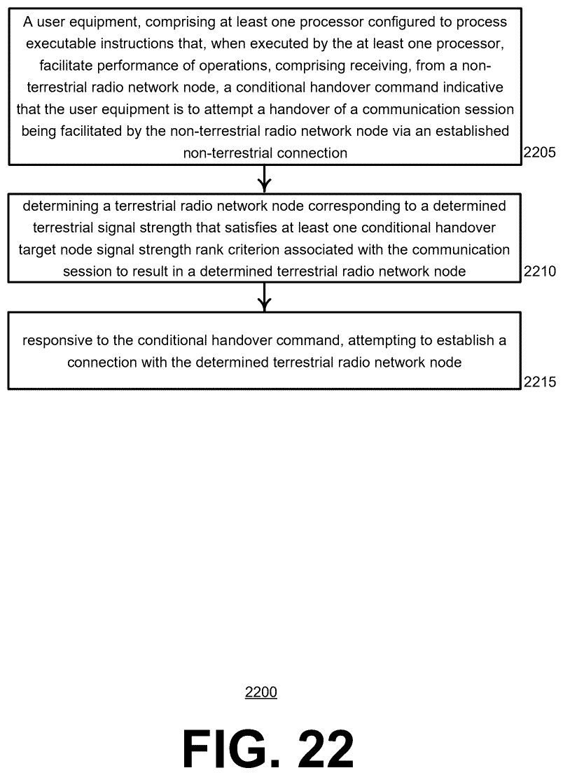

Turning now to FIG. 22, the figure illustrates an example user equipment 2200, comprising at block 2205 at least one processor configured to process executable instructions that, when executed by the at least one processor, facilitate performance of operations, comprising receiving, from a non-terrestrial radio network node, a conditional handover command indicative that the user equipment is to attempt a handover of a communication session being facilitated by the non-terrestrial radio network node via an established non-terrestrial connection; at block 2210 determining a terrestrial radio network node corresponding to a determined terrestrial signal strength that satisfies at least one conditional handover target node signal strength rank criterion associated with the communication session to result in a determined terrestrial radio network node; and at block 2215 responsive to the conditional handover command, attempting to establish a connection with the determined terrestrial radio network node.

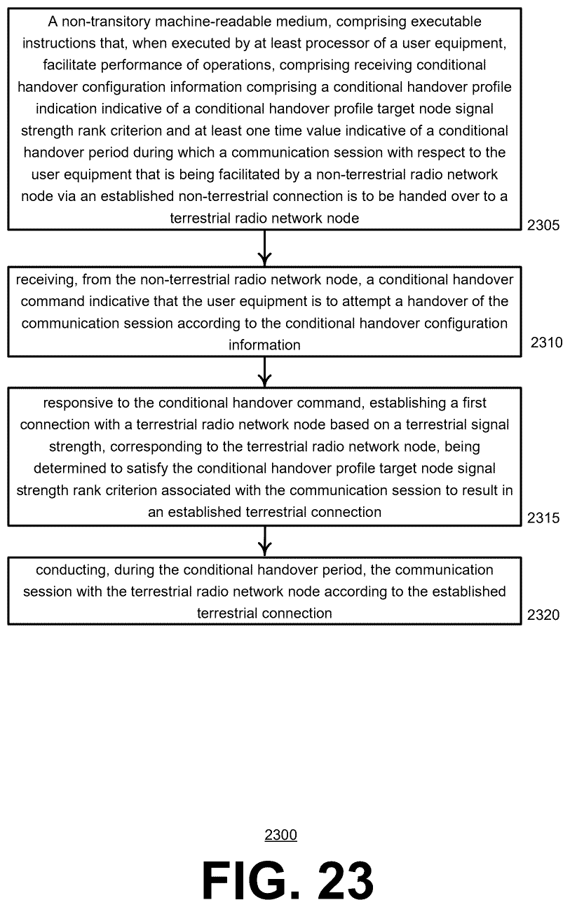

Turning now to FIG. 23, the figure illustrates a non-transitory machine-readable medium 2300 comprising at block 2305 executable instructions that, when executed by at least one processor of a user equipment, facilitate performance of operations, comprising receiving conditional handover configuration information comprising a conditional handover profile indication indicative of a conditional handover profile target node signal strength rank criterion and at least one time value indicative of a conditional handover period during which a communication session with respect to the user equipment that is being facilitated by a non-terrestrial radio network node via an established non-terrestrial connection is to be handed over to a terrestrial radio network node; at block 2310 receiving, from the non-terrestrial radio network node, a conditional handover command indicative that the user equipment is to attempt a handover of the communication session according to the conditional handover configuration information; at block 2315 responsive to the conditional handover command, establishing a first connection with a terrestrial radio network node based on a terrestrial signal strength, corresponding to the terrestrial radio network node, being determined to satisfy the conditional handover profile target node signal strength rank criterion associated with the communication session to result in an established terrestrial connection; and at block 2320 conducting, during the conditional handover period, the communication session with the terrestrial radio network node according to the established terrestrial connection.

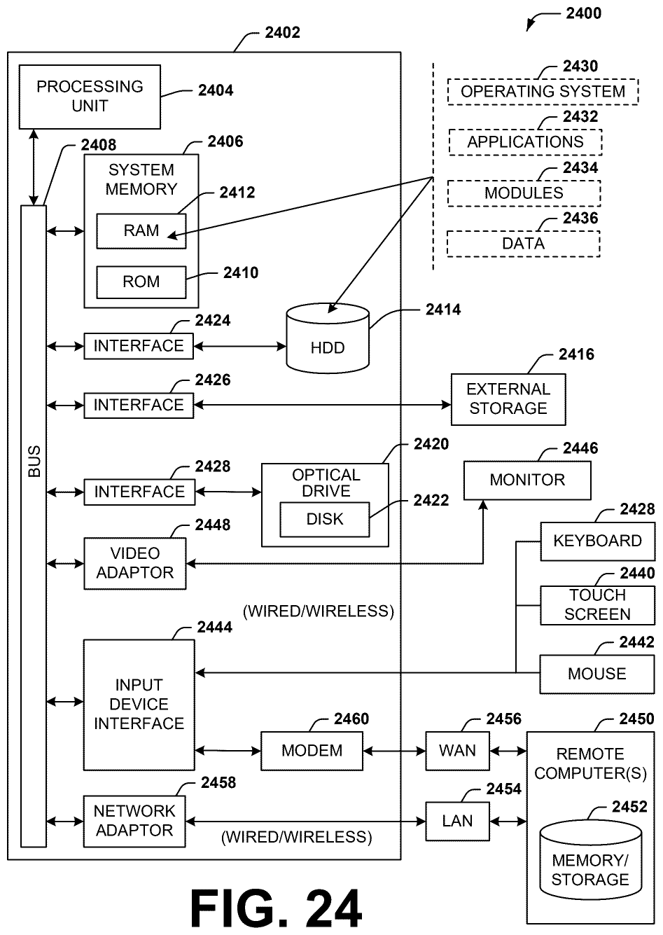

In order to provide additional context for various embodiments described herein, FIG. 24 and the following discussion are intended to provide a brief, general description of a suitable computing environment 2400 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 24, the example environment 2400 for implementing various embodiments of the aspects described herein includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors and may include a cache memory. Dual microprocessors and other multi-processor architectures can also be employed as the processing unit 2404.

The system bus 2408 can be any of several types of bus structure that can further interconnect to a memory bus (with or without a memory controller), a peripheral bus, and a local bus using any of a variety of commercially available bus architectures. The system memory 2406 includes ROM 2410 and RAM 2412. A basic input/output system (BIOS) can be stored in a non-volatile memory such as ROM, erasable programmable read only memory (EPROM), EEPROM, which BIOS contains the basic routines that help to transfer information between elements within the computer 2402, such as during startup. The RAM 2412 can also include a high-speed RAM such as static RAM for caching data.

Computer 2402 further includes an internal hard disk drive (HDD) 2414 (e.g., EIDE, SATA), one or more external storage devices 2416 (e.g., a magnetic floppy disk drive (FDD) 2416, a memory stick or flash drive reader, a memory card reader, etc.) and an optical disk drive 2420 (e.g., which can read or write from a CD-ROM disc, a DVD, a BD, etc.). While the internal HDD 2414 is illustrated as located within the computer 2402, the internal HDD 2414 can also be configured for external use in a suitable chassis (not shown). Additionally, while not shown in environment 2400, a solid-state drive (SSD) could be used in addition to, or in place of, an HDD 2414. The HDD 2414, external storage device(s) 2416 and optical disk drive 2420 can be connected to the system bus 2408 by an HDD interface 2424, an external storage interface 2426 and an optical drive interface 2428, respectively. The interface 2424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2412, including an operating system 2430, one or more application programs 2432, other program modules 2434 and program data 2436. All or portions of the operating system, applications, modules, and/or data can also be cached in the RAM 2412. The systems and methods described herein can be implemented utilizing various commercially available operating systems or combinations of operating systems.

Computer 2402 can optionally comprise emulation technologies. For example, a hypervisor (not shown) or other intermediary can emulate a hardware environment for operating system 2430, and the emulated hardware can optionally be different from the hardware illustrated in FIG. 24. In such an embodiment, operating system 2430 can comprise one virtual machine (VM) of multiple VMs hosted at computer 2402. Furthermore, operating system 2430 can provide runtime environments, such as the Java runtime environment or the .NET framework, for applications 2432. Runtime environments are consistent execution environments that allow applications 2432 to run on any operating system that includes the runtime environment. Similarly, operating system 2430 can support containers, and applications 2432 can be in the form of containers, which are lightweight, standalone, executable packages of software that include, e.g., code, runtime, system tools, system libraries and settings for an application.

Further, computer 2402 can comprise a security module, such as a trusted processing module (TPM). For instance, with a TPM, boot components hash next in time boot components, and wait for a match of results to secured values, before loading a next boot component. This process can take place at any layer in the code execution stack of computer 2402, e.g., applied at the application execution level or at the operating system (OS) kernel level, thereby enabling security at any level of code execution.

A user can enter commands and information into the computer 2402 through one or more wired/wireless input devices, e.g., a keyboard 2438, a touch screen 2440, and a pointing device, such as a mouse 2442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2404 through an input device interface 2444 that can be coupled to the system bus 2408, but can be connected by other interfaces, such as a parallel port, an IEEE 1394 serial port, a game port, a USB port, an IR interface, a BLUETOOTH® interface, etc.

A monitor 2446 or other type of display device can be also connected to the system bus 2408 via an interface, such as a video adapter 2448. In addition to the monitor 2446, a computer typically includes other peripheral output devices (not shown), such as speakers, printers, etc.

The computer 2402 can operate in a networked environment using logical connections via wired and/or wireless communications to one or more remote computers, such as a remote computer(s) 2450. The remote computer(s) 2450 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2452 is illustrated. The logical connections depicted include wired/wireless connectivity to a local area network (LAN) 2454 and/or larger networks, e.g., a wide area network (WAN) 2456. Such LAN and WAN networking environments are commonplace in offices and companies, and facilitate enterprise-wide computer networks, such as intranets, all of which can connect to a global communications network, e.g., the internet.

When used in a LAN networking environment, the computer 2402 can be connected to the local network 2454 through a wired and/or wireless communication network interface or adapter 2458. The adapter 2458 can facilitate wired or wireless communication to the LAN 2454, which can also include a wireless access point (AP) disposed thereon for communicating with the adapter 2458 in a wireless mode.

When used in a WAN networking environment, the computer 2402 can include a modem 2460 or can be connected to a communications server on the WAN 2456 via other means for establishing communications over the WAN 2456, such as by way of the internet. The modem 2460, which can be internal or external and a wired or wireless device, can be connected to the system bus 2408 via the input device interface 2444. In a networked environment, program modules depicted relative to the computer 2402 or portions thereof, can be stored in the remote memory/storage device 2452. It will be appreciated that the network connections shown are example and other means of establishing a communications link between the computers can be used.

When used in either a LAN or WAN networking environment, the computer 2402 can access cloud storage systems or other network-based storage systems in addition to, or in place of, external storage devices 2416 as described above. Generally, a connection between the computer 2402 and a cloud storage system can be established over a LAN 2454 or WAN 2456 e.g., by the adapter 2458 or modem 2460, respectively. Upon connecting the computer 2402 to an associated cloud storage system, the external storage interface 2426 can, with the aid of the adapter 2458 and/or modem 2460, manage storage provided by the cloud storage system as it would other types of external storage. For instance, the external storage interface 2426 can be configured to provide access to cloud storage sources as if those sources were physically connected to the computer 2402.

The computer 2402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

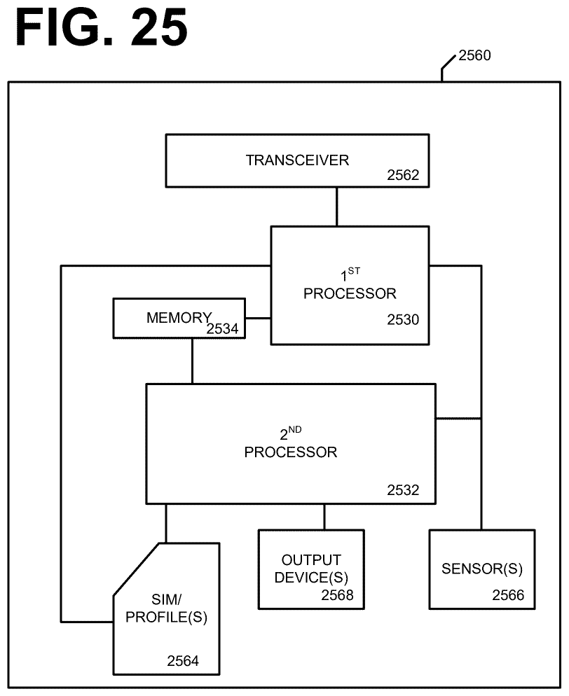

Turning to FIG. 25, the figure illustrates a block diagram of an example UE 2560. UE 2560 may comprise a smart phone, a wireless tablet, a laptop computer with wireless capability, a wearable device, a machine device that may facilitate vehicle telematics, a tracking device, remote sensing devices, and the like. UE 2560 comprises a first processor 2530, a second processor 2532, and a shared memory 2534. UE 2560 includes radio front end circuitry 2562, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 2562 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 25, UE 2560 may also include a SIM 2564, or a SIM profile, which may comprise information stored in a memory (memory 2534 or a separate memory portion), for facilitating wireless communication with RAN 105 or core network 130 shown in FIG. 1. FIG. 25 shows SIM 2564 as a single component in the shape of a conventional SIM card, but it will be appreciated that SIM 2564 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 2564 and another device, which may be a component of RAN 105 or core network 130 shown in FIG. 1). A SIM profile 2564 may also comprise identifying information that is unique to the SIM, or SIM profile, such as, for example, an International Mobile Subscriber Identity (“IMSI”) or information that may make up an IMSI.

SIM 2564 is shown coupled to both the first processor portion 2530 and the second processor portion 2532. Such an implementation may provide an advantage that first processor portion 2530 may not need to request or receive information or data from SIM 2564 that second processor 2532 may request, thus eliminating the use of the first processor acting as a ‘go-between’ when the second processor uses information from the SIM in performing its functions and in executing applications. First processor 2530, which may be a modem processor or a baseband processor, is shown smaller than processor 2532, which may be a more sophisticated application processor, to visually indicate the relative levels of sophistication (i.e., processing capability and performance) and corresponding relative levels of operating power consumption levels between the two processor portions. Keeping the second processor portion 2532 asleep/inactive/in a low power state when UE 2560 does not need it for executing applications and processing data related to an application provides an advantage of reducing power consumption when the UE only needs to use the first processor portion 2530 while in listening mode for monitoring routine configured bearer management and mobility management/maintenance procedures, or for monitoring search spaces that the UE has been configured to monitor while the second processor portion remains inactive/asleep.

UE 2560 may also include sensors 2566, such as, for example, temperature sensors, accelerometers, gyroscopes, barometers, moisture sensors, and the like that may provide signals to the first processor 2530 or second processor 2532. Output devices 2568 may comprise, for example, one or more visual displays (e.g., computer monitors, VR appliances, and the like), acoustic transducers, such as speakers or microphones, vibration components, and the like. Output devices 2568 may comprise software that interfaces with output devices, for example, visual displays, speakers, microphones, touch sensation devices, smell or taste devices, and the like, that are external to UE 2560.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| AI | Artificial intelligence |
| ML | Machine learning |
| QCI | QoS Class Identifiers |
| BSR | Buffer status report |
| SBFD | Sub-band full duplex |
| CLI | Cross link interference |
| TDD | Time division duplexing |
| FDD | Frequency division duplexing |
| AI | Artificial intelligence |
| ML | Machine learning |
| MCS | Modulation and coding scheme |
| IE | Information element |
| BS | Base station |
| RRC | Radio resource control |
| UCI | Uplink control information |
| UE | User equipment |
| WTRU | Wireless transmit receive unit |
| CBR | Channel busy ratio |
| SCI | Sidelink control information |
| QoS | Quality of service |
| PER | Packet error rate |
| PDB | Packet delay budget |
| E2E | End to end |
| NES | Network energy saving |
| QCI | Quality class indication |
| RSRP | Reference signal received power |
| PCI | Primary cell ID |
| CSI-RS | Channel state information reference signals |
| PTRS | Phase tracking reference signals |
| DTX | Discontinuous transmission or discontinuous transmit |
| DRX | Discontinuous reception or discontinuous receive |
| CG | Configured grant |
| ULP | Uplink power |
| FBS | Fake base station |
| NTN | Non terrestrial network |
| gRAN | Ground radio access network |
| RAN | Radio access network |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a terrestrial radio network node comprising at least one processor, receiving, from at least one user equipment, at least one connection establishment request comprising a conditional handover indication;
responsive to the at least one connection establishment request and based on the conditional handover indication, facilitating, by the terrestrial radio network node, directing, to at least one non-terrestrial radio network node that is facilitating at least one communication session with the at least one user equipment, at least one session transfer request indicative of at least one of the at least one user equipment with respect to which at least one of the at least one communication session is to be facilitated by the terrestrial radio network node;
responsive to the at least one session transfer request, facilitating, by the terrestrial radio network node, receiving session transfer information, directed to the terrestrial radio network node by a first network element associated with the at least one non-terrestrial radio network node, corresponding to the at least one communication session to be facilitated by the terrestrial radio network node during a conditional handover period; and
facilitating, by the terrestrial radio network node during the conditional handover period, delivery of traffic corresponding to the at least one communication session with respect to the at least one user equipment according to the session transfer information.

2. The method of claim 1, further comprising:
facilitating, by the terrestrial radio network node, receiving conditional handover configuration information, directed to the terrestrial radio network node by a second network element associated with the at least one non-terrestrial radio network node, wherein the conditional handover configuration information comprises at least one time value indicative of the conditional handover period.

3. The method of claim 1, further comprising:
after the conditional handover period, facilitating, by the terrestrial radio network node, directing, to a second network element associated with the at least one non-terrestrial radio network node, updated session information corresponding to the at least one communication session.

4. The method of claim 3, wherein the first network element and the second network element are different.

5. The method of claim 3, wherein at least one of the first network element or the second network element comprises at least one of: a core network element; a shared terrestrial/non-terrestrial network element; a gateway; or the at least one non-terrestrial radio network node.

6. The method of claim 3, wherein the updated session information comprises at least one of: a downlink packet number corresponding to a last downlink packet delivered by the terrestrial radio network node to the at least one user equipment, a downlink packet number corresponding to a last downlink packet delivered by the terrestrial radio network node to the at least one user equipment, or a quality of service indication indicative of a quality of service associated with the at least one communication session.

7. The method of claim 3, further comprising:
after the directing of the updated session information to the second network element, flushing, by the terrestrial radio network node, the updated session information.

8. The method of claim 1, wherein the at least one connection establishment request is transmitted by the at least one user equipment based on at least one conditional handover command, directed to the at least one user equipment by the at least one non-terrestrial radio network node, indicative to the at least one user equipment to attempt transfer of the at least one communication session according to at least one conditional handover target node signal strength rank.

9. The method of claim 8, wherein the terrestrial radio network node corresponds to the at least one conditional handover target node signal strength rank.

10. The method of claim 9, wherein the terrestrial radio network node is a first terrestrial radio network node that corresponds to a first signal strength, with respect to the at least one user equipment, and wherein the first signal strength is less than a second signal strength, with respect to the at least one user equipment, that corresponds to a second terrestrial radio network node.

11. A terrestrial radio network node, comprising at least one processor configured to process executable instructions that, when executed by the at least one processor, facilitate performance of operations, comprising:
receiving, from a user equipment, a connection establishment request comprising a conditional handover indication indicative of a request to handover, to the terrestrial radio network node, delivery of communication traffic corresponding to a communication session being facilitated by a non-terrestrial radio network node;
responsive to the conditional handover indication, transmitting, to the non-terrestrial radio network node, a transfer request indicative of the user equipment;
responsive to the transfer request, receiving session transfer information, directed to the terrestrial radio network node by a first network element associated with the non-terrestrial radio network node, corresponding to the communication session to be facilitated by the terrestrial radio network node during a conditional handover period; and
delivering, during the conditional handover period, the communication traffic according to the session transfer information.

12. The terrestrial radio network node of claim 11, wherein the terrestrial radio network node is a first terrestrial radio network node, wherein a first terrestrial signal strength, corresponding to the first terrestrial radio network node, with respect to the user equipment is lower than a second terrestrial signal strength, corresponding to a second terrestrial radio network node, with respect to the user equipment, and wherein the first terrestrial signal strength corresponds to a conditional handover target node signal strength rank that corresponds to a quality of service corresponding to the communication session.

13. The terrestrial radio network node of claim 12, wherein the connection establishment request is transmitted by the user equipment based on a conditional handover command, directed to the user equipment by the non-terrestrial radio network node, indicative to the user equipment to attempt transfer of the communication session according to the conditional handover target node signal strength rank.

14. The terrestrial radio network node of claim 11, wherein the connection establishment request comprises a non-terrestrial radio network node identifier indicative of the non-terrestrial radio network node with respect to which handover of the delivering of the communication traffic is requested by the connection establishment request.

15. The terrestrial radio network node of claim 11, wherein the operations further comprise:
responsive to the transfer request, receiving, from the non-terrestrial radio network node, at least one time indication indicative of the conditional handover period.

16. The terrestrial radio network node of claim 11, wherein the operations further comprise:
after expiration of the conditional handover period, directing, to the non-terrestrial radio network node, updated session information corresponding to the delivering, during the conditional handover period, of the communication traffic; and
after the directing of the updated session information to the non-terrestrial radio network node, flushing the updated session information.

17. A non-transitory machine-readable medium, comprising executable instructions that, when executed by at least one processor of a terrestrial radio network node, facilitate performance of operations, comprising:
receiving, from a user equipment, a connection establishment request comprising a conditional handover indication indicative of a request to handover, to the terrestrial radio network node, delivery of communication traffic corresponding to a communication session being facilitated by a non-terrestrial radio network node;
responsive to the conditional handover indication, transmitting, to the non-terrestrial radio network node a session transfer request indicative of the user equipment;
responsive to the session transfer request, receiving session transfer information, comprising session context information corresponding to the communication session, directed to the terrestrial radio network node by a first network element associated with the non-terrestrial radio network node, corresponding to the communication session to be facilitated by the terrestrial radio network node during a conditional handover period;
facilitating, during the conditional handover period, delivering of the communication traffic according to the session transfer information;
determining that the conditional handover period has expired;
based on the conditional handover period being determined to have expired, directing, to the non-terrestrial radio network node, updated session information corresponding to the delivery, during the conditional handover period, of the communication traffic; and
flushing the updated session information.

18. The non-transitory machine-readable medium of claim 17, wherein the terrestrial radio network node is a first terrestrial radio network node, wherein a first terrestrial signal strength corresponding to the first terrestrial radio network node with respect to the user equipment is lower than a second terrestrial signal strength corresponding to a second terrestrial radio network node with respect to the user equipment, wherein the first terrestrial signal strength corresponds to a conditional handover target node signal strength rank, wherein the connection establishment request is transmitted by the user equipment based on a conditional handover command, directed to the user equipment by the non-terrestrial radio network node, indicative to the user equipment to attempt transfer of the communication session according to the conditional handover target node signal strength rank, and wherein the conditional handover command is indicative to the user equipment to transmit the connection establishment request to the terrestrial radio network node according to the conditional handover target node signal strength rank.

19. The non-transitory machine-readable medium of claim 18, wherein the conditional handover target node signal strength rank corresponds to a quality of service associated with the communication session.

20. The non-transitory machine-readable medium of claim 17, wherein the connection establishment request comprises a non-terrestrial radio network node identifier indicative of the non-terrestrial radio network node with respect to which handover of the delivery of the communication traffic is requested by the connection establishment request.
